(19) United States
(12) Patent Application Publication
(10) Pub. No.: US 2026/0353056 A1
(43) Pub. Date: Nov. 5, 2026

(54) COMMUNICATION METHOD BETWEEN A WEIGHING DEVICE AND A MOBILE DEVICE, METHODS USED IN A RETAIL ENVIRONMENT THAT USE THIS COMMUNICATION METHOD, WEIGHING METHOD THAT CONTRIBUTES TO WASTE REDUCTION IN A RETAIL ENVIRONMENT, AND RELATED COMPUTER PROGRAMS, SYSTEMS AND DEVICES

(71) Applicant: Mettler-Toledo (Albstadt) GmbH, Albstadt (DE)

(72) Inventors: René Plantade, Bad Nauheim (DE); Torsten Rahn, Nuremberg (DE); Werner Engeln, Dettenhausen (DE)

(21) Appl. No.: 19/487,800

(22) PCT Filed: May 30, 2024
(86) PCT No.: PCT/EP2024/064907

§ 371 Date: Nov. 25, 2025

(30) Foreign Application Priority Data
Jun. 2, 2023 (CH) CH000585/2023

(51) Int. Cl. H04W 4/80; G06Q 20/20

(52) U.S. Cl. CPC H04W 4/80; G06Q 20/208

(57) ABSTRACT

The present invention relates to a communication method between a weighing device and a mobile device. Communication is initiated using a unique session identifier generated in reaction to a request for establishing the communication. The present invention further relates to use of this communication method in a retail environment, in particular a weighing method and a method for operating a weighing device. According to a secondary aspect of the present invention, a weighing method contributes to waste reduction by integrating a customer container in a weighing process in a customer-friendly manner. The present invention relates further to a computer program product and computer programs, to a system, to a weighing device, and to a mobile device, the foregoing being configured to implement at least one of the mentioned methods.

The present invention is related to a communication method between a weighing device and a mobile device and to methods used in a retail environment and that use this communication method, in particular to a weighing method and a method for operating a weighing device. The present invention relates further to a weighing method contributing to waste reduction. This weighing method may be part of the weighing method that uses the communication method, or it may be a separate (stand-alone) weighing method. Further, the present invention relates to a computer program product and computer programs, to a system, to a weighing device, and to a mobile device, wherein the computer program product, the computer programs, the system, the weighing device, and the mobile device are configured to implement at least one of the mentioned methods.

In recent years, retail environments in which a customer uses their own mobile device, e.g., a smartphone, for self-checkout have become more and more popular. For example, the mobile device may be used for scanning of barcodes of products to be purchased or for electronic payment. In the case that the product to be purchased is sold by weight, there exist proposals to transmit the weighing value of the product which is obtained by a weighing device, or a price of the product calculated from the weighing value to the mobile device of the customer by the weighing device.

For example, WO 2022/008936 A1 discloses a system comprising a weighing scale, a server and a terminal device, e.g., a smartphone. The weight of an article weighed by the weighing scale is stored, together with a weighing scale identifier code associated with the scale, in a look-up table on the server. A user may input the weighing scale identifier code in the terminal device, and thereupon the weight measurement value associated with the weighing scale identifier code is retrieved from the look-up table by the terminal device.

U.S. Pat. No. 10,247,598 B2 discloses a method for displaying a weighing result of a scale on a mobile display device. The scale is associated with a unique identifier. The mobile display device establishes a secure, wireless communication connection with the scale and displays the unique identifier of the scale after successfully establishing the connection. In this way, a user may check with which scale of a plurality of scales, e.g., in a retail environment, they are connected. In one of the disclosed embodiments only the scale with the displayed identifier may display the weighing result in the mobile display device.

EP 2779065 A1 discloses a method of operating a produce weighing scale having a weighing platform wherein a customer scans with a mobile device a barcode which identifies the produce weighing scale.

US 2021/0326828 A1 discloses a sales system including a weighing and pricing device and a mobile terminal. Upon establishing a connection between the mobile device and the weighing and pricing device, the weighing and pricing device receives, from the mobile device, identification information that identifies the mobile device.

U.S. Pat. No. 10,758,066 B2 discloses a method wherein an item is weighed by a weighing device, the weighing value of the item is displayed on the scale and a picture of the weighing value is taken by a mobile device. The item weight is then identified from the picture by artificial intelligence. Furthermore, it is disclosed that location information reported by the mobile device combined with the image of the item that needs to be weighed is used to identify the weighing device.

All the solutions mentioned above rely on a communication between the weighing device and the mobile device. There are usually a plurality of mobile devices and a plurality of weighing devices present in a retail environment and it is key to make sure that the right communication partners pair, this means that the weighing device that generates weighing transaction information for a specific item pairs only with the mobile device associated to the customer that intends to purchase this specific item, and that there is no opportunity, neither for the customer nor for the retailer nor of a third party, to manipulate the information that is exchanged between the right communication partners.

State-of-the-art approaches, for example as disclosed in the above-summarized documents, have various drawbacks with respect to fulfillment of the requirement of guaranteeing pairing of the right communication partners only and with respect to fulfillment of the requirement of a tamper-proof communication. For example, there are actions needed that are carried out by the user and that are additional to and not in line with state-of-the-art shopping processes, the devices needed are expensive, the approaches are at least one of complex, relying on external services and error-prone, and/or pairing the right communication partners only cannot be fulfilled for all cases with a probability that is sufficient.

It is an object of the present invention to propose a communication method between a mobile device, in particular a customer-owned mobile device, and a weighing device that fulfills the requirement of guaranteeing pairing only of the right communication partners and the requirement of a tamper-proof communication, and that overcomes at least one of the above-mentioned drawbacks of state-of-the-art methods.

It is a further object of the present invention to improve the shopping experience of a customer by at least one of simplifying the weighing and, as the case may be, pricing process when a mobile device, in particular a customer-owned mobile device, is involved, contributing to frictionless shopping, eliminating or at least reducing the need for touching shop equipment, and contributing to individualization of the shopping experience, in particular of the weighing and, as the case may be, pricing process. Said individualization may comprise the use of customer-specific presets, customer-owned devices, such as the mobile device and/or a customer-owned container, and customer-owned and/or customer-controlled software, for example.

It is a further object of the present invention to provide methods and processes carried out in a retail environment, wherein the provided methods and processes rely on the proposed communication method. In particular, a weighing method and a method for operating a weighing device are provided.

According to a secondary aspect of the invention, a weighing method that is able to contribute to waste reduction by integrating a customer container in a weighing process in a customer-friendly manner is provided. A weighing method according to this secondary aspect comprises the communication method optionally, only.

It is a further object of the present invention to provide at least one of a computer program product, a computer program, a system, a weighing device, and a mobile device configured for carrying out at least one of the provided methods and processes.

It is yet a further object of the present invention to provide methods, computer program products, computer programs, systems, and devices that are “legal-for-trade”.

At least one of these objects is achieved by the invention as claimed and described in the following.

The provided communication method allows a user of a mobile device in particular to seamlessly interact with a weighing device. The user may use their mobile device for all relevant interactions with the weighing device, so that there is no need to physically touch the weighing device, e.g., a weighing device key for initiating the weighing process. In this way, sanitary standards may be increased, and a barrier-free operation of the weighing device may be enabled. For example, for special needs customers, e.g., for blind and partially sighted customers, the provided communication method may enable an autonomous interaction with the weighing device. The communication method implements or contributes to frictionless commerce. The invention may help to avoid media breaks.

Furthermore, the user may customize their own user settings in the mobile device, in particular in a mobile device computer program for communication with the weighing device, thereby simplifying the interaction with the weighing device for the user. I.e., the user does not need to get accustomed to the settings of the weighing device.

The provided communication method may be beneficial for the implementation of a single device strategy. The method comprises a communication between the user's mobile device and one particular weighing device. The weighing device is only acting as a sensor. The weighing device is integrated in the sales process in a standardized way.

Even further, the communication process between the mobile device and the weighing device is under control of the user. This is even true when user specific interactions are involved. Further, user-related data are under control of the user.

Another advantage of the provided methods may be low implementation costs. The methods may reduce the number and complexity of features of the weighing device. For example, in embodiments of the methods, the weighing device does not need at least one of the following features: a camera, a barcode scanner, a specific communication module, a display, a user interface, in particular an electronic user interface, such as a graphical user interface (GUI).

According to a first aspect of the present invention, at least one of these goals is attained by a communication method, in particular a computer-implemented communication method, between a weighing device and a mobile device, the method comprising a step of initiating the communication using a unique session identifier that is generated in reaction to a request for establishing the communication. In particular, a unique session identifier is generated in reaction to each request for establishing a communication. For example, a unique session identifier is generated for each query-response instance.

In other words, the method comprises a step of initiating a communication between a weighing device and a mobile device, wherein a unique session identifier is used in the step of initiating the communication, wherein the unique session identifier is generated in reaction to a request for establishing a communication. In particular, a unique session identifier is generated in reaction to each request for establishing a communication. For example, a unique session identifier is generated for each query-response instance.

A generation of a request for establishing a communication, for example the generation of a request for establishing a communication according to any embodiment disclosed below, may be considered as a step of initiating the generation of a unique session identifier. This is because the unique session identifier, in particular each unique session identifier, is generated in reaction to a request for establishing a connection between the weighing device and the mobile device.

An established communication allows to exchange information between the mobile device and the weighing device, in particular information as specified below, such as a product identifier, weighing transaction information and/or tare information, but also order status, target weight, frequent shopper status etc.

The communication may use a standardized plugin for communication.

The communication may be established via Bluetooth, Bluetooth Low Energy (BLE), WLAN or Near Field Communication (NFC), but it is not limited to this.

The communication that is initiated using a unique session identifier may be a direct communication between the weighing device and the mobile device, or it may be an indirect communication between the weighing device and the mobile device. Embodiments of the method comprising a direct or indirect communication between the weighing device and the mobile device are described further below.

In an embodiment, the communication is an ad-hoc short-living communication.

In particular, the communication may be an ad-hoc short-living communication by being limited, in an automated manner, to a period starting automatically and instantly as soon as the unique session identifier was provided to a communication module of the weighing device and to a communication module of the mobile device, and ending automatically and instantly with receiving weighing transaction information by the mobile device and/or with providing, for example sending, weighing transaction information in a manner that the mobile device can receive it. The ending event may comprise providing a reception confirmation.

Alternatively, the communication may be an ad-hoc short-living communication by being limited, in an automated manner, to a period starting automatically and instantly as soon as the weighing device and the mobile device were attributed to the unique session identifier, and ending automatically and instantly with receiving weighing transaction information by the mobile device and/or with providing, for example sending, weighing transaction information in a manner that the mobile device can receive it. The ending event may comprise providing a reception confirmation.

The weighing transaction information may include a weighing value of an object placed on the weighing device for weighing, optionally a price of the object calculated on the basis of the weighing value and/or a price per unit weight of the object, and optionally a product identifier for the object, for example.

The communication may be an ad-hoc short-living communication by the direct connection that is established exclusively for the direct communication between the weighing device and the mobile device being ad-hoc and short-living, for example by being limited as disclosed before.

The communication may be an ad-hoc short-living communication by a communication session between the weighing device and the mobile device being ad-hoc and short-living, for example by being limited as disclosed before.

The mobile device is usually a mobile device of the user, in particular customer, such as a user smartphone. However, there are embodiments in which the mobile device is a mobile device of an operator, for example service technician or store personnel, and/or store-owned.

The mobile device may comprise input means for inputting data and/or user inputs into the mobile device and output means for outputting data. The output means may comprise display means. In one example, the mobile device may comprise a touchscreen for inputting and outputting the data/the user input. The mobile device may comprise further electronic data processing means including a mobile device processor and a mobile device data carrier. A mobile device computer program, e.g., an app, for initiating and carrying out the communication may be installed on the mobile device data carrier and may be executable by the mobile device processor.

Contrary to the prior art, the mobile device is not only a means for displaying and/or storing weighing information, but it plays at least in some embodiments an active role as a communication partner. This will be evident from the following.

The weighing device may comprise means for obtaining a weighing value of an object to be weighed, a weighing device processor and a weighing device data carrier. A weighing device computer program for initiating and carrying out the communication may be installed on the weighing device data carrier and may be executable by the weighing device processor of the weighing device. The weighing device may be a retail scale and/or a self-service scale, preferably used in a retail environment in one example.

“Unique session identifier” means that there are, at least within a local area and/or during a given period of time, not two session identifiers involved in a communication that are identical. For example, the local area may be the area of a specific store. For example, the given period of time may be such that a session identifier that is attributed to two different weighing and, as the case may be, pricing processes is excluded. For example, a session identifier may be available again only after a preceding weighing and, as the case may be, pricing process ended and/or after a period of time that is long enough to guarantee that the preceding weighing and, as the case may be, pricing process ended or became obsolete. The period of time may be, for example, 5 minutes or more, for example 10, 15, 20 or 30 minutes. Alternatively, the period of time may end at or after store closure, this means each unique session identifier may be available exactly once a day.

In particular, a unique session identifier that is generated in reaction to a request for establishing a communication allows for a communication between exactly one weighing device and exactly one mobile device at a given time. This does not rule out that the same unique session identifier is used later again for a communication between the same exactly one mobile device and the same or another exactly one weighing device. In other words, the communication method is setup that there cannot be communications running in parallel and using the same unique session identifier. However, in embodiments, the communication method may be setup that there are communications running in series, wherein these communications use the same unique session identifier and are between a specific mobile device and a weighing device that may be same or different in the communications of the series of communications.

However, in many embodiments, a unique session identifier allows for exactly one communication between exactly one weighing device and exactly one mobile device.

In particular, the unique session identifier is different from and does not comprise any weighing device identifier code, any mobile device identifier code, and any user identifier code. In other words, the unique session identifier itself does not comprise or give any hint towards the weighing device, the mobile device, and the user. In this, in particular in identifying a specific session by a unique session identifier, the method is contrary to the state of the art where a scale identifier ID as in WO 2022/008936A1, U.S. Pat. No. 10,247,598 B2 or EP 2779065 A, or a mobile device identifier as in US 2021/0326828 A1 is involved. In other words, processes, in particular process steps, transactions and/or interactions, are identified in methods according to the first aspect of the invention instead of devices or users. The processes are, in particular, weighing processes. A process is represented by a unique session identifier. In embodiments, the mobile device and the weighing device may further be associated with only one process, in particular one transaction or one interaction, at a time. Furthermore, since a unique session identifier is involved, a simultaneous interaction of several mobile devices with the weighing device or a simultaneous interaction of several weighing devices with a mobile device may be prevented.

The unique session identifier may be provided in any suitable representation. A static representation, for example of a QR-or barcode, a dynamic representation, such as a movie or sequence of images, or an audio signal are examples of possible representations of the unique session identifier. In other words, the unique session identifier may be provided in any machine-detectable representation, in particular in any representation that may be detected and processed by a standard mobile device, in particular a standard mobile phone.

The communication may be considered as a rendezvous communication.

The uniqueness of the session identifier may be global in one example. In another example, the uniqueness of the session identifier may depend on the co-location and/or the time frame for the potential communication partners.

As mentioned, initiation of the communication between the weighing device and the mobile device comprises using a unique session identifier. The unique session identifier may be generated by the weighing device, the mobile device, or a device that is different, for example remote, from the weighing device and the mobile device.

In the following, the terms “remote system”, “backend system”, “remote device”, “remote server” etc. stand for a computing mean or computing means that is/are not an integral part of the weighing device or the mobile device and that is/are configured to communicate, for example with the weighing device and the mobile device, to store information, and to execute computer programs, if not stated otherwise. The computing mean(s) may be cloud-based.

One of the following may apply in embodiments of the method:
In one embodiment generating said unique session identifier may be by the weighing device and said method may further comprise providing the generated unique session identifier to the mobile device, e.g. by comprising a step of providing the unique session identifier, this step may be according to any embodiment disclosed below.
In an alternative embodiment, the unique session identifier may be generated by the mobile device and may thereafter be provided to the weighing device, e.g. by comprising a step of providing the unique session identifier, this step may be according to any embodiment disclosed below.
In a further alternative embodiment, the method may further comprise providing a backend (remote) system, e.g., a server. In this embodiment, the mobile device and the weighing device may be both connected to the server, or they may establish a connection with the server, for example, via WLAN or a Web-application. I.e., a communication channel between the weighing device and the mobile device is in principle already existing. However, the communication channel between the weighing device and the mobile device is not open for communication, yet. Then, the weighing device or the mobile device may initiate the generation of the unique session identifier on the server. The method may further comprise providing the generated unique session identifier to the weighing device and the mobile device, e.g. by comprising a step of providing the unique session identifier, this step may be according to any embodiment disclosed below, and/or a step of attributing the weighing device and the mobile device to the unique session identifier, this step may be according to any embodiment disclosed below.

The generated unique session identifier may be passed between the weighing device and the mobile device with each subsequent data communication until the communication is terminated.

A request for establishing a communication, in particular each request for establishing a communication, may be generated in a step of generating a request for establishing a communication, wherein this step comprises a user action that is indicative for a weighing event that will take place soon. In other words, a user action may cause a device to initiate the generation of a unique session identifier because, as mentioned above, the generation of a request for establishing a communication, may be considered as a step of initiating the generation of a unique session identifier.

In an embodiment, the step of generating a request for establishing a communication comprises at least one of:
Placing an object on the weighing device. The object may be an object to be weighed and/or a container for an object to be weighted, for example. The object that is placed on the weighing device may be a container in which the object to be weighed is arranged.
The object may be the first object of a plurality of objects that will be placed on the weighing device, wherein it is only this first object of the plurality of objects that generates a request for establishing a communication. In particular, this may be the case if the communication method is used in a method for purchasing an object, wherein this method comprises working through a list of products that are weighed one after the other, for example. The below mentioned product identifier list is an example of such a list of products.
Establishing a near-field communication (NFC) between the weighing device and the mobile device. In this text, the term “near-field communication” includes any kind of communication that is suitable, in particular in an automated manner, for determining a user's intention to pair her/his mobile device with a specific weighing device by a presence of the mobile device in a given and limited range around the weighing device and for establishing, in particular in an automated manner, a communication channel between the mobile device and the weighing device.
A user action carried out on the mobile device, such as proceeding to a step “weighing” in an app running on the mobile device, initiating weighing in an app running on the mobile device, scanning a product identifier, indicating user authentication information etc.

Since the generation of a request for establishing a communication may be considered as a step of initiating the generation of a unique session identifier, the unique session identifier, in an embodiment, is generated by the weighing device, for example in reaction to detecting that an item (object) was placed on the weighing device or after initialization of a near-field communication. Alternatively, the unique session identifier, in an embodiment, may be generated by the mobile device, for example in reaction to receiving or selecting a product identifier or after initialization of a near-field communication. According to both embodiments, the communication may then start automatically and instantly as soon as the device that did not generate the unique session identifier received this unique session identifier, for example by the method comprising a step of providing the unique session identifier according to any embodiment disclosed.

Alternatively to the generation of the unique session identifier by the weighing device or the mobile device in reaction to one of the above-listed events, the unique session identifier may be generated by a device that is different, for example remote, from the weighing device and the mobile device. For example, the above and below mentioned remote system may generate the unique session identifier. The unique session identifier may be generated by this device after initiation by the weighing device, e.g. after detecting that an item (object) was placed on the weighing device or after initialization of a near-field communication, or by the mobile device, e.g. after receiving or selecting a product identifier or after initialization of a near-field communication. The communication may then start automatically and instantly as soon as both the weighing device and the mobile device received the unique session identifier from the device, for example by the method comprising a step of providing the unique session identifier according to any embodiment disclosed, or as soon as both the weighing device and the mobile device were attributed to the unique session identifier, for example by the method comprising a step of attributing according to any embodiment disclosed.

As mentioned, the communication that is initiated using a unique session identifier may be a direct communication between the weighing device and the mobile device on a direct connection between the weighing device and the mobile device, wherein the direct connection is established exclusively for this direct communication. For example, the direct connection may be a Bluetooth, in particular a Bluetooth Low Energy (BLE), connection or a Near Field Communication (NFC) connection.

Alternatively, the communication that is initiated using a unique session identifier may be a communication via a remote (also called backend) system, such as a remote communication service, a remote server and/or a remote device, on a connection between the weighing device and the remote system, and a connection between the mobile device and the remote system, wherein these connections have been established already or are established routinely by the weighing device and the mobile device. A WLAN connection, a connection via a cellular network (mobile network), and an at least partly wired connection, in particular for the connection between the weighing device and the remote system, are examples of connections via the remote system. The connection may use, for example, a Web-application. In the case of a communication via a remote system, the connection that is initiated may be considered as a communication session between the weighing device and the mobile device on a connection of the weighing device and a connection of the mobile device to a remote system, wherein these connections are standard connections for state-of-the-art weighing devices and mobile devices. In other words, there is a communication channel between the weighing device and the mobile device via the remote system and the communication between the weighing device and the mobile devices is carried out during the communication session.

In embodiments of the method, one of the following alternatives may apply:
The communication method comprises a step of establishing, using a unique session identifier, a direct communication between the weighing device and the mobile device. Alternatively or in addition, the only devices involved during carrying out the method are the weighing device and the mobile device.
The communication method comprises a step of establishing, using a unique session identifier, a communication between the weighing device and the mobile device via a remote system. In other words, the communication method comprises a step of establishing, using a unique session identifier, an indirect communication between the weighing device and the mobile device.
The communication method comprises a step of distributing a unique session identifier via a remote system and/or a step of attributing the weighing device and the mobile device to the unique session identifier, and a step of establishing, using the distributed unique session identifier, a communication between the weighing device and the mobile device, wherein the communication is either a direct communication or an indirect communication via the remote system. The step of distributing may correspond to the step of providing the unique session identifier according to any embodiment disclosed and the step of attributing may be according to any embodiment disclosed.

In an embodiment, the method comprises a step of making sure that the weighing device and the mobile device can be identified via the unique session identifier.

In particular, the step of making sure that the weighing device and the mobile device can be identified via the unique session identifier comprises at least one of a step of providing the unique session identifier to a communication module of the weighing device and to a communication module of the mobile device, and a step of attributing the weighing device and the mobile device to the unique session identifier.

After having made sure that the weighing device and the mobile device can be identified via the unique session identifier, for example after the unique session identifier is available for both the weighing device and the mobile device or after both the weighing device and the mobile device are attributed to the unique session identifier, a communication between the weighing device and the mobile device may be, and usually is, established automatically. As mentioned, the communication may allow to exchange information, in particular information that is relevant for pricing, between the mobile device and the weighing device. As mentioned, the communication may be closed instantly after sending the information, and optionally after receipt of a reception confirmation, alternatively after reception of the information by the respective device. I.e., the communication may be a short-living communication.

In embodiments comprising the step of providing the unique session identifier to a communication module of the weighing device and to a communication module of the mobile device, this step of providing may comprise at least one of:
A step of detecting, in particular by the mobile device, a representation of the unique session identifier.
Therefore, the unique session identifier may be provided in any suitable representation. A static representation, for example a QR-or barcode, a dynamic representation, such as a movie or sequence of images, or an audio signal are examples of possible representations of the unique session identifier. In particular, the unique session identifier may be provided in any machine-detectable representation, in particular in any representation that may be detected and processed by a standard mobile device, in particular a standard mobile phone.
In an embodiment, the step of detecting a representation of the unique session identifier is or comprises a step of acquiring a picture or a sequence of pictures of a displayed representation of the unique session identifier. The representation of the unique session identifier is then a machine-readable presentation of the unique session identifier. The representation of the unique session identifier may be provided, for example displayed, by the device that generated the unique session identifier.
A user action by which the user provides a representation of the unique session identifier in a direct manner, for example a step of entering manually, e.g. using a user interface, a displayed representation of the unique session identifier. In particular, the unique session identifier is provided to the mobile device.
A step of transferring the unique session identifier from or via a remote system to at least one of the weighing device and the mobile device.
A step of establishing a near-field communication, in particular a step of transferring the unique session identifier from the weighing device to the mobile device or, in some embodiments, from the mobile device to the weighing device via a near-field communication.

For example, the method may comprise the step of detecting a representation of the unique session identifier and may comprise further:

A step of providing means for scanning a barcode or QR code to the mobile device;

A step of providing display means;

A step of encoding the unique session identifier in a barcode or a QR-code and displaying the barcode or QR-code on the display means;

A step of providing the generated unique session identifier to the mobile device by scanning the barcode or QR-code with the mobile device before the communication is established.

Generally, state of the art mobile devices come along with a camera and applications for extracting a barcode or QR code from a camera picture, so that a barcode scanner is already implemented in current mobile devices by default. In this case, the scanning may be by taking a picture of the displayed barcode or QR code with the camera of the mobile device. The scanning with the means for scanning may be carried out by the user. This embodiment enables a particularly simple way to provide the unique session identifier to the mobile device as the mobile device may retrieve the unique session identifier from said picture. Ways to encode the unique session identifier in the barcode or QR code are known in the art.

In one example of the embodiment where the unique session identifier is generated by the weighing device or the generation of the unique session identifier is initiated by the weighing device, the display means may be provided to the weighing device. For example, the display device may be or may comprise a screen of the weighing device. Encoding of the unique session identifier in the barcode or QR code may be by the weighing device or the device that generated the unique session identifier after initiation by the weighing device, in this example.

As the unique session identifier is communicated via a communication channel which is different from the communication channel used for the communication between the weighing device and the mobile device in this embodiment, security is improved. Furthermore, an easy way to communicate the unique session identifier to the mobile device is provided in this embodiment.

In embodiments comprising the remote system, the remote system may provide the unique session identifier only to the “right” (correct) weighing device and only to the “right” (correct) mobile device or the remote system may attribute the “right” (correct) weighing device only and the “right” (correct) mobile device only to the unique session identifier.

For example, the unique session identifier may be provided to the device that initiated generation of the unique session identifier, or the device that initiate generation of the unique session identifier may be attributed to the unique session identifier, and the device that did not initiate generation of the unique session identifier may be identified by providing an app on the mobile device, wherein the app guides the user in a manner that the device that did not initiate generation of the unique session identifier can be identified, for example by considering the time of events registered by the remote system.

In an embodiment, initiating the communication comprises a step of determining that an object was placed on the weighing device and at least one of:
A step of confirming by a user on the mobile device that the user placed an object on the weighing device.
A step of initiating by a user on the mobile device a transfer of a product identifier from the mobile device to the weighing device and/or to a remote system that is connected to the weighing device.
A step of initiating by a user on the mobile device a transfer of a container information from the mobile device to the weighing device and/or to a remote system that is connected to the weighing device.

Anyone of these steps may be performed within the app that guides the user in a manner that the device that did not initiate generation of the unique session identifier can be identified.

Independent of where and in reaction to which event the unique session identifier is generated and of how the unique session identifier is provided to the communication module of the weighing device and to the communication module of the mobile device, or of how the weighing device and the mobile device are attributed to the unique session identifier, the established communication between the weighing device and the mobile device may be a direct communication or an indirect communication via the remote system.

As mentioned, there are usually a plurality of weighing devices and a plurality of mobile devices, whereby each weighing device of the plurality of weighing devices has a plurality of mobile devices as potential pairing partners and vice versa. In this case, the method, according to an embodiment, may comprise generation of the unique session identifier by the mobile device and may comprise communicating indirectly the unique session identifier to each weighing device of said plurality of weighing devices by indirect communication through the remote (backend) system. The unique session identifier may be displayed by each of the weighing devices, and a user may select one of the weighing devices and verify whether the following transaction is assigned the correct unique session identifier, e.g., by comparing the unique session identifier displayed on the weighing device with the unique session identifier displayed on their mobile device. To this end, each weighing device may comprise display means.

The communication method according to any embodiment disclosed may be used in various methods used in a retail environment, for example in a weighing method, in particular a weighing method that is part of purchasing an object that needs to be weighed, or in a method for operating a weighing device.

Hence, a second aspect of the present invention relates to a weighing method, in particular a computer-implemented weighing method, and a third aspect of the present invention relates to a method for operating a weighing device, in particular a computer-implemented method for operating a weighing device.

A method according to the second aspect, this means a weighing method according to the present invention, comprises a communication method according to any embodiment disclosed above and comprises further:
A step of placing an object to be weighed on the weighing device, said object being associated with a product identifier. Said placing may cause the generation of the unique session identifier. However, as it was disclosed with respect to the step of generating a request for establishing a communication, other events may cause the generation of the unique session identifier. The unique session identifier may be generated by the weighing device, the remote device or the mobile device according to any embodiment disclosed with respect to the communication method. However, if it is the placing of the object on the weighing device that causes the generation of the unique session identifier, it is usually the weighing device or the remote device that generates the unique session identifier.
The object to be weighed may be placed on the weighing device while it is arranged in a container. If this is the case, the method may comprise a weighing method that is able to contribute to waste reduction according to any embodiment disclosed below.
Upon initiation of the communication, a step of communicating the product identifier to the weighing device, in particular by the mobile device.
A step of weighing the object by the weighing device to thereby obtain a weighing value of the object and generating weighing transaction information at least on the basis of said weighing value and the product identifier.
A step of communicating the weighing transaction information to the mobile device by the weighing device and thereafter terminating the communication between the weighing device and the mobile device. In particular, the step of communicating the weighing transaction information is in response to the communicated product identifier.

A product identifier is or comprises information that allows a device, in particular the weighing device, the remote system or the mobile device, to clearly identify a product (individual object or group of objects), namely the product to which the product identifier is associated, for example for retrieving further information of the product, such as its unit price, the name of the product and/or a picture of product. The product identifier may be a product identifier code. Providing of the product identifier of an object to be weighed may be initiated by the mobile device, possible examples for said initiating being explained below.

The weighing of the object may be performed by the weighing device upon placing the object to be weighed on the weighing device or after communication of the product identifier to the weighing device, but it is not limited to this. The weighing transaction information may include the weighing value of the object and optionally, a price of the object calculated on the basis of the weighing value and/or a price per unit weight of the object in one example. To this end, a data table comprising for each product identifier the associated price per unit weight may be stored on the weighing device or remotely, in particular on the remote system. The generating of the weighing transaction information may be by the weighing device.

The event that causes termination of the communication may be one of the events disclosed with respect to the communication method. In particular, termination of the communication may be instantly after the weighing device has sent the weighing transaction information in one example. In another example, the communication may be terminated upon receipt of the weighing transaction information by the mobile device. In yet another example, the communication may be terminated upon confirmation of receipt of the weighing transaction information by the mobile device.

In an embodiment, the weighing method comprises a communication that provides weighing transaction information of the object to be weighed, wherein the unique session identifier is created once the object to be weighed is placed on the weighing device and wherein the product identifier is provided by the mobile device to the weighing device to which the weighing device immediately responds with sending the associated weighing transaction information to the mobile device after which the connection is instantly closed.

In an embodiment, the method may comprise a step of working through a product identifier list provided by the mobile device. In particular, the method may comprise weighing the products listed in a product identifier list one after the other.

In particular, the product identifier list may be generated by the user, in particular by selecting objects that need to be weighed and by not weighing them immediately after selection.

The product identifier list may be generated by an app running on the mobile device. For example, an entry of the list may be generated in an automated manner after scanning a product identifier and/or after selecting a product in a product list provided by the app.

In an embodiment, the weighing method according to any embodiment disclosed may further comprise:
A step of providing a data table, said data table comprising for each of a plurality of objects to be weighed the associated product identifier;
A step of displaying a graphical representation of each object of said plurality on the mobile device, and a step of selecting the object to be weighed among the displayed objects by a user input; and
A step of retrieving the product identifier from the data table by the mobile device in response to the user input.

The data table may be the product identifier list, or it may be a table comprising all objects of a store that need to be weighed.

The data table may be stored on the data carrier of the mobile device in one example. In another example, the data table may be stored on the remote system, in particular on a server or server thereof, and the mobile device may access the information of the data table by communication with the remote system. The data table may be created by the owner of the weighing device or shop in which the weighing device is located in one example. The displaying of the graphical representation of the objects to be weighed may include displaying icons or text strings of their identifying names. The user may then touch the icon or text string on the touchscreen thereby selecting the object to be weighed.

In another embodiment, the weighing method according to any embodiment disclosed may further comprise:
The step of providing a data table, said data table comprising for each of a plurality of objects to be weighed the associated product identifier;
A step of providing a camera to the mobile device;
A step of capturing an image of the object to be weighed by the camera;
A step of automatically selecting said product identifier from the data table on the basis of the captured image.

As above, the data table may be the product identifier list, or it may be a table comprising all objects of a store that need to be weighed.

As above, the data table may be stored on the data carrier of the mobile device in one example. In another example, the data table may be stored on the remote system, in particular on a server or server thereof, and the mobile device may access the information of the data table by communication with the remote system. The data table may be created by the owner of the weighing device or shop in which the weighing device is located in one example.

The camera used for capturing an image of the object to be weighed may be the camera with which state-of-the-art mobile devices are standardly equipped. This also means that the camera used for capturing the image and the camera used for detecting a representation of the unique session identifier may be the same camera in embodiments of the weighing method in which the communication method applied in the weighing method comprises providing the generated unique session identifier to the mobile device by detecting a representation of the unique identifier by the mobile device, wherein this representation is displayed on display means, in particular display means of the weighing device, and wherein the representation of the unique session identifier may be a barcode or QR-code that is scanned with the mobile device, for example.

Capturing the image with the camera may be carried out by the user.

Said automatic selection may be assisted by image recognition which may comprise the use of machine learning and/or artificial intelligence in one example. The automatic selection may be carried out by the mobile device in one example, e.g. by using a respective software. In another example the automatic selection may be carried out by the remote system, in particular a server or server thereof.

In an embodiment, said the weighing method according to any embodiment disclosed may further comprise:
A step of providing a machine-readable representation of the product identifier of the object to be weighed;
A step of providing a camera to the mobile device or, as the case may be, the step of providing a camera to the mobile device;
A step of capturing an image of the machine-readable identifier representation by the camera and retrieving the product identifier on the basis of said image.

The machine-readable representation of the product identifier of the object may be a barcode or QR code in one example. The machine-readable representation of the product identifier may be attached to the object to be weighed or it may be provided in its proximity, e.g. on a shelf where the object is stored. Retrieving of the product identifier may be by the mobile device, e.g. by using a software for decoding a barcode or QR code. In another example, said machine-readable representation of the product identifier may be a text string. Then, retrieving of the product identifier may be assisted by image recognition, preferably by said mobile device. Alternatively, the mobile device may provide the machine-readable representation of the product identifier to the remote system, wherein it is the remote system that retrieves the product identifier. The remote system may then provide information related to the object represented by the product identifier to the mobile device. The name of the object and/or a picture of the object are examples of information that may be provided to the mobile device.

As above, the camera used for capturing an image of the machine-readable identifier representation may be the camera with which state-of-the-art mobile devices are standardly equipped. In embodiments, this camera may be used in other steps of the method, such as the step of capturing an image of the object to be weighed and/or the step of detecting a representation of the unique session identifier.

Capturing the image by the camera may be carried out by the user.

According to the above embodiments and examples, the product identifier may be chosen by the user from a pre-defined list or automatically recognized using a camera picture.

An important goal of present-day retail is the reduction of waste, e.g., due to packing of goods or due to excess food bought by a customer. Therefore, retailers offer their customers for example to carry their own containers for filling in the amount of a product they want to buy. Such shops are equipped with dispensers that dispense bulk foods such as cereals, nuts, tea, dry fruits, etc., in bulk, for example. If the bulk food is sold by weight, and the weighing is carried out once the food is placed inside the container, it may be necessary that the container weight is known in order to obtain the weight of the purchased food and to thereby calculated its price. WO2022/226649A1, WO2022/008936A1, and US2011/0270696A1 disclose methods for integrating customer-owned containers in a weighing and/or shopping process.

Thus, a weighing method that is able to contribute to waste reduction is provided. This weighing method may be part of any embodiment of the weighing method comprising the communication method according to any embodiment disclosed. In other words, the weighing method comprising the communication method may comprise further the method that is able to contribute to waste reduction according to any embodiment disclosed in the following. However, the weighing method that is able to contribute to waste reduction may be a separate, this means stand-alone, method. In other words, the weighing method that is able to contribute to waste reduction may be considered as another aspect of the invention, this aspect being not linked to other aspects of the invention, such as the communication method or the weighing method comprising the communication method, or this aspect being only optionally linked to other aspects of the invention. For example, there may be embodiments of the weighing method that is able to contribute to waste reduction that comprise the communication method according to any embodiment disclosed and/or the weighing method comprising the communication method according to any embodiment disclosed. The latter means that, in embodiments, the weighing method that is able to contribute to waste reduction may further be according to the weighing method comprising the communication method, the weighing method comprising the communication method being according to any embodiment disclosed.

The weighing method that is able to contribute to waste reduction comprises the following steps:
A step of arranging an object (the object, as the case may be) to be weighed in a container having a container weight.
A step of communicating a tare information associated with said container weight to a weighing device (to the weighing device, as the case may be) by a mobile device (by the mobile device, as the case may be) before a weighing transaction information (the weighing transaction, as the case may be) is generated by the weighing device.
A step of weighing of the object arranged inside the container by the weighing device to thereby obtain a total weighing value of the object and the container. In other words, the object and the container are weighed together, wherein the object is arranged inside the container.

Further, generating said weighing transaction information is at least on the basis of said total weighing value and said tare information.

In particular, it is the weighing device that determines the weight of the object to be weighed. Further, the weighing device may be, and usually is, the price calculating device. The weighing device may display at least one of the weight of the object and the calculated price of the object on display means of the weighing device, or it may initiate the display of at least one of the weight of the object and the calculated price of the object on another device, such as a display of the mobile device or another display that is visible to the customer. As mentioned, the weighing method that is able to contribute to waste reduction may comprise the communication method according to any embodiment disclosed by comprising the communication method according to any embodiment disclosed or by comprising the weighing method comprising the communication method according to any embodiment disclosed. This also means that the communication established between the mobile device and the weighing device may be according to any embodiment disclosed with respect to the communication method. Alternatively, the weighing method that is able to contribute to waste reduction may be used in combination with any other communication method between a mobile device and a weighing device.

The weighing device may be according to any embodiment disclosed with respect to the communication method and/or the weighing method comprising the communication method. In methods that comprise the communication method according to any embodiment disclosed, for example by comprising any embodiment of the weighing method comprising the communication method, and the weighing method that is able to contribute to waste reduction according to any embodiment disclosed, the weighing device may be the weighing device according to any embodiment disclosed with respect to the communication method and/or disclosed with respect to the weighing method comprising the communication method.

The mobile device may be according to any embodiment disclosed with respect to the communication method and/or the weighing method comprising the communication method. In methods that comprise the communication method according to any embodiment disclosed, for example by comprising any embodiment of the weighing method comprising the communication method, and the weighing method that is able to contribute to waste reduction according to any embodiment disclosed, the mobile device may be the mobile device according to any embodiment disclosed with respect to the communication method and/or disclosed with respect to the weighing method comprising the communication method.

The weighing transaction information may be according to any embodiment disclosed with respect to the communication method and/or the weighing method comprising the communication method, or may comprise such weighing transaction information. In methods that comprise the communication method according to any embodiment disclosed, for example by comprising any embodiment of the weighing method comprising the communication method, and the weighing method that is able to contribute to waste reduction according to any embodiment disclosed, the weighing transaction information may be the weighing transaction information according to any embodiment disclosed with respect to the communication method and/or disclosed with respect to the weighing method comprising the communication method, or may comprise such weighing transaction information.

The container may be any means for packaging the object, including paper and plastic bags which may have negligible weight. The tare information may include the information that the weight of the container is zero or close to zero in this case. However, the container may have a non-negligible weight in another example. Said arranging may be carried out by the user.

The tare information may include the container weighing value. Said communication of the tare information is carried out after the initiation of the communication between the mobile device and the weighing device. The tare information may be communicated together with a product identifier (the product identifier, as the case may be) in one example. In an example where the weighing transaction information includes the weighing value of the object to be weighed, said weighing value may be calculated by subtracting the container weight from the total weight. Said calculating may be performed by the weighing device in one example.

In an embodiment, the method that is able to contribute to waste reduction may further comprise providing a tare information table to the mobile device, said tare information table comprising for each of a plurality of containers a container identifier and the associated container weight. The container identifier may comprise a container identifier code, e.g. text data, image data or any other data identifying the container. Then, the method may further comprise displaying a graphical representation of each container of the plurality of containers, e.g., by an icon, optionally in combination with the associated container weight, on the touchscreen of the mobile display device. In one example, the graphical representation may comprise a graphical representation of the container or a picture thereof. Then, the user may select the container in which the object to be weighed is arranged and enter their selection into the mobile display device via a user input, e.g. by touching the graphical representation upon which the tare information associated with the selected container is communicated to the weighing device.

The tare information needs to be provided during carrying out the weighing method that is able to contribute to waste reduction. Thus, according to an embodiment, said weighing method may further comprise:
A step of requesting creation of tare information associated with a chosen container by a user input into the mobile device;
A step of placing the chosen, empty container on the weighing device;
A step of weighing the chosen, empty container by the weighing device to obtain a container weighing value;
A step of creating said tare information on the basis of the container weighing value, preferably by the weighing device;
A step of communicating said tare information to the mobile device, preferably by the weighing device.

The steps listed above may be considered as the steps of a method for generating tare information or, as the case may be, a tare information table. This method may be considered as another aspect of the invention, this aspect being not linked to other aspects of the invention, such as the communication method or any weighing method, or this aspect being only optionally linked to other aspects of the invention.

The step of placing the chosen, empty container on the weighing device may cause the generation of a unique session identifier in embodiments in which the tare information is communicated to the mobile device using a communication between the weighing device and the mobile device that is established by carrying out the communication method according to any embodiment described above. For example, the unique session identifier may be displayed as a barcode or QR code on display means and said barcode or QR code may be scanned with the mobile device as explained above to thereby initiate the communication between the mobile device and the weighing device.

In one example, said method may comprise displaying a tare information creating icon on the touchscreen of the mobile device, and said user input may be by touching said icon. In a further example, the mobile device may prompt the user to provide a picture of the container, e.g. by using the camera of the mobile device to thereby create the associated container identifier, and may further prompt the user to place the empty container on the weighing device by displaying said prompts on the touchscreen. Said placing of the container may be carried out by the user.

The communication of the tare information is performed once the communication between the mobile device and the weighing device has been initiated.

In one example of the above embodiment, said tare information may be used for the creation of the tare information table comprising for each of a plurality of containers the container identifier and the associated container weight as explained above. Said tare information table may be created and/or updated by the mobile device upon receipt of the tare information in one example. In one example said tare information table may be stored on the mobile device. In one example, the tare information table may include tare information of standard containers which cannot be removed from the tare information table by a user input.

Independent of whether the weighing method is a weighing method comprising the communication method and/or being able to contribute to waste reduction, and independent of the embodiment of the weighing method, the generated weighing transaction information may be transferred to a virtual basket and/or used for automatic payment. Said transfer may be to the mobile device in one example. In another example, this transfer may be to the remote system, in particular a server or a server thereof, or to a point of sales (POS) device.

As mentioned, the communication method according to any embodiment disclosed may be used in various methods used in a retail environment, and the present invention, according to a third aspect, relates to a method for operating a weighing device.

This is the case because the method according to the first aspect of the present invention, this means the communication method, allows in principle data exchange between the mobile device and the weighing device beyond the exchange of information related to a weighing and, as the case may be, pricing process. In particular, one may think of scenarios in which it would be beneficial that service personnel may acquire information relevant for maintaining of the weighing device from the weighing device, while another user, e.g., a customer of a shop, does not have access to this kind of information.

A method according to the third aspect, this means a method for operating a weighing device, comprises a communication method according to any embodiment disclosed above and comprises the following steps:
A step of associating user authentication information to a user of the mobile device, said user authentication information being associated with access permissions to the weighing device, said access permissions being preferably in accordance with a user group affiliation of the user;
A step of providing said user authentication information to the mobile device;
A step of communicating, by the mobile device, said user authentication information to the weighing device.

The user authentication information is communicated after the initiation of the communication.

The user authentication information is provided to the weighing device using the communication between the mobile device and the weighing device that is established by carrying out the communication method.

Examples of user groups may comprise “customer” with limited access rights, in particular, with access rights limited to receiving weighing transaction information comprising weighing values from the weighing device and “operator” with extended access rights, in particular with access rights extended to receiving information relevant for maintaining the weighing device from the weighing device. The access permissions may be assigned by an authorized administrator and stored in a data table.

In an embodiment of the method for operating a weighing device, said user may be affiliated with an operator group, said access permissions may include access to information relevant for maintaining the weighing device, and wherein said method may further comprise:
A step of creating information relevant for the maintaining of the weighing device, preferably by the weighing device;
A step of communicating said information relevant for maintaining the weighing device to the mobile device by the weighing device upon receipt of said user authentication information by the weighing device.

In this way, a user with operator rights may be allowed access to a restricted area of the weighing device.

In one example, said creation of information for the maintaining may be by the weighing device on the basis of weighing device status information.

The information relevant for maintaining of the weighing device and the user authentication information are communicated using the communication between the mobile device and the weighing device that is established by carrying out the communication method.

The invention provides further devices, systems, and computer programs (and related signals, media and methods) configured for carrying out any of the above-disclosed method according to any embodiment disclosed or for being used in any of the above-disclosed method according to any embodiment disclosed.

According to a fourth aspect of the present invention, there is provided a computer program product comprising a weighing device software module to be executed by a weighing device, preferably by a weighing device according to any embodiment disclosed, and a mobile device software module to be executed by a mobile device, preferably by a mobile device according to any embodiment disclosed, wherein the weighing device software module and the mobile device software module carry instructions which, when the weighing device software module is executed by the weighing device and the mobile device software module is executed by the mobile device, cause the weighing device and the mobile device to implement at least one of the communication method according to any embodiment disclosed, the weighing method according to any embodiment disclosed, and the method of operating a weighing device according to any embodiment disclosed.

“Cause the weighing device and the mobile device to implement” means that the weighing device and the mobile device are caused to carry out the computer-implemented steps of, as the case may be, the communication method according to any embodiment disclosed, the weighing method according to any embodiment disclosed, and/or the method of operating a weighing device according to any embodiment disclosed. Which steps that are computer-implemented and which steps are not computer-implemented, in particular carried out by a user, is evident from the above description of said methods.

In general, if the term “implement” or “implementing” is used with respect to a computer program product, a software module, a computer program, a device on which a software module or computer program is executed, or devices on which a computer program product is executed, the term implies that the computer-implemented steps are caused to be carried out (executed) by the computer program product, the software module, the computer program, the device on which the software module or computer program is executed, or the devices on which the computer program product is executed. The non computer-implemented steps are still carried out by the user, for example. However, the computer program product, the software module, the computer program, the device on which the software module or computer program is executed, or the devices on which the computer program product is executed may comprise a step of prompting a user for an input. This means the computer program product, the software module, the computer program, the device on which the software module or computer program is executed, or the devices on which the computer program product is executed may cause or contribute to a guided human-machine interaction process.

The term “implement” or “implementing” may have, for example, the meaning of “carry(ing) out” or of “support(ing)” a method in dependence of whether there are non computer-implemented steps or not.

In particular, there is provided a computer program product for implementing a communication between a weighing device and a mobile device, preferably between the weighing device and the mobile device of the system according to the fifth aspect of the present invention disclosed below, said computer program product comprising a weighing device software module to be executed by the weighing device and a mobile device software module to be executed by the mobile device, wherein the weighing device software module and the mobile device software module carry instructions which, when the weighing device software module is executed by the weighing device and the mobile device software module is executed by the mobile device, cause the communication between the weighing device and the mobile device according to anyone of the above embodiments according to the first aspect of the present invention. In embodiments in which a remote system is involved in the communication between the weighing device and the mobile device, the computer program product may comprise further a remote system software module to be executed by the remote system. In this case, the weighing device software module, the mobile device software module and the remote system software module carry instructions which, when the weighing device software module is executed by the weighing device, the mobile device software module is executed by the mobile device and the remote system software module is executed by the remote system, cause the communication between the weighing device and the mobile device according to anyone of the above embodiments according to the first aspect of the present invention in which a remote system is involved.

Alternatively or in addition, the computer program product, in particular its weighing device software module, its mobile device software module and, as the case may be, its remote system software module, may comprise instructions which, when the software modules are executed by the weighing device, the mobile device and, as the case may be, the remote system respectively, cause the weighing device and the mobile device to implement, in particular support, a weighing method according to any embodiment disclosed and/or a method for operating a weighing device according to any embodiment disclosed.

In particular the mobile device software module may support a weighing method according to any embodiment disclosed and/or a method for operating a weighing device according to any embodiment disclosed by implementing a guided human-machine interaction process.

The mobile device software module may be or comprise the app running on the mobile device according to any embodiment disclosed.

A software module may be considered as a computer program.

The mobile device software module, the weighing device software module or, as the case may be, the remote system software module may be provided separately, instead of providing the computer program product.

In particular, the invention provides the mobile device software module, this means a computer program comprising instructions which, when the computer program is executed by a computer of a mobile device, preferably a mobile device according to any embodiment disclosed, cause the mobile device to implement, at least one of the communication method according to any embodiment disclosed, the weighing method according to any embodiment disclosed, and the method for operating a weighing device according to any embodiment disclosed.

The invention concerns further, a reproducible computer-readable signal encoding at least one of the weighing device software module, the mobile device software module and, as the case may be, the remote system software module, that, when loaded and executed on a computer of the corresponding device (i.e. weighing device, mobile device, remote system), causes the corresponding device(s) to implement at least one of the communication method according to any embodiment disclosed, the weighing method according to any embodiment disclosed, and the method of operating a weighing device according to any embodiment disclosed.

In particular, the reproducible computer-readable signal may encode the mobile device software module, this means the computer program mentioned before.

The invention concerns further a computer-readable medium having stored thereon instruction which, when executed by a computer of at least one of the weighing device, the mobile device, and, as the case may be, the remote system cause the device(s) by which computer(s) the instructions are executed (i.e. weighing device, mobile device, and/or remote system) to implement at least one of the communication method according to any embodiment disclosed, the weighing method according to any embodiment disclosed, and the method of operating a weighing device according to any embodiment disclosed.

In particular, the computer-readable medium has stored thereon instruction which, when executed by a computer of a mobile device, preferably a mobile device according to any embodiment disclosed, cause the mobile device to implement at least one of the communication method according to any embodiment disclosed, the weighing method according to any embodiment disclosed, and the method of operating a weighing device according to any embodiment disclosed.

The invention concerns further a data carrier signal carrying instructions which, when executed by a computer of at least one of the weighing device, the mobile device, and, as the case may be, the remote system cause the device(s) by which computer(s) the instructions are executed (i.e. weighing device, mobile device, and/or remote system) to implement at least one of the communication method according to any embodiment disclosed, the weighing method according to any embodiment disclosed, and the method of operating a weighing device according to any embodiment disclosed.

In particular, the data carrier signal carries instruction which, when executed by a computer of a mobile device, preferably a mobile device according to any embodiment disclosed, cause the mobile device to implement at least one of the communication method according to any embodiment disclosed, the weighing method according to any embodiment disclosed, and the method of operating a weighing device according to any embodiment disclosed.

The invention concerns further a method for manufacturing a non-transitory computer readable medium, comprising the step of storing, on the computer readable medium, computer-executable instruction which, when executed by a processor of at least one of the weighing device, the mobile device and, as the case may be, the remote system, cause the device(s) by which processor(s) the instruction is executed (i.e. weighing device, mobile device, and/or remote system) to implement at least one of the communication method according to any embodiment disclosed, the weighing method according to any embodiment disclosed, and the method of operating a weighing device according to any embodiment disclosed.

In particular, the invention concerns a method for manufacturing a non-transitory computer readable medium comprising the step of storing, on the computer readable medium, computer executable instruction, which when executed by a processor of a mobile device, preferably of a mobile device according to any embodiment disclosed, cause the mobile device to implement at least one of the communication method according to any embodiment disclosed, the weighing method according to any embodiment disclosed, and the method of operating a weighing device according to any embodiment disclosed.

According to a fifth aspect of the present invention, there is provided a system comprising a weighing device and a mobile device, said system being configured to implement at least one of the communication method between the weighing device and the mobile device according to any embodiment disclosed, the weighing method according to any embodiment disclosed, and the method for operating a weighing device according to any embodiment disclosed.

Everything that has been said above in relation to the first to fourth aspect of the present invention also applies to the system according to the fifth aspect of the present invention. In particular, the weighing device and the mobile device may be according to any embodiment disclosed so far.

In particular, the weighing device may comprise any feature or combination of features disclosed so far and/or any feature configured for carrying out a function of the weighing device disclosed so far.

In particular, the mobile device may comprise any feature or combination of features disclosed so far and/or any feature configured for carrying out a function of the mobile device disclosed so far.

The system may comprise any further component in any embodiment disclosed with respect to first to fourth aspect. In particular, the system may further comprise the remote system that may be a remote communication service, a server or a remote device, for example. In such embodiments, the weighing device and the mobile device may be configured to connect with said server, and the communication between the weighing device and the mobile device may be an indirect communication via the server in one example. In another example, the communication may be a direct communication between the weighing device and the mobile device, nevertheless.

The system may comprise the app that runs on the mobile device, a corresponding app that runs on the weighing device and, as the case may be, a corresponding app that runs on the remote system.

The system may comprise the computer program product according to any embodiment disclosed.

According to a sixth aspect of the present invention, there is provided a weighing device that is configured to implement at least one of the communication method between the weighing device and the mobile device according to any embodiment disclosed, the weighing method according to any embodiment disclosed, and the method for operating a weighing device according to any embodiment disclosed. In particular, the weighing device may be configured to be used in at least one of a method according to the first, a method according to the second, and a method according to the third aspect, or to contribute to carrying out at least one of said methods.

In particular, at least one of the following may apply:
The weighing device may be configured for initiating the communication using a unique session identifier that is generated in reaction to a request for establishing the communication.
The weighing device may be configured for generating the unique session identifier and/or for transforming a user action into a request for establishing the communication.
The weighing device may be configured for generating the weighing transaction information according to any embodiment disclosed and for communicating it to the mobile device or to the remote system.
The weighing device may be configured for generating the tare information associated with a chosen container according to any embodiment disclosed and for communicating it to the mobile device or to the remote system.

Everything that has been said above in relation to the first to fourth aspect of the present invention also applies to the weighing device according to the sixth aspect of the present invention. In particular, the weighing device may be according to any embodiment disclosed so far.

In particular, the weighing device may comprise any feature or combination of features disclosed so far and/or any feature configured for carrying out a function of the weighing device disclosed so far.

According to a seventh aspect of the present invention, there is provided a mobile device that is configured to implement at least one of the communication method between the weighing device and the mobile device according to any embodiment disclosed, the weighing method according to any embodiment disclosed, and the method for operating a weighing device according to any embodiment disclosed. In particular, the mobile device may be configured to be used in at least one of a method according to the first, a method according to the second, and a method according to the third aspect, or to contribute to carrying out at least one of said methods.

In particular, at least one of the following may apply:
The mobile device may be configured for initiating the communication using a unique session identifier that is generated in reaction to a request for establishing the communication.
The mobile device may be configured for generating the unique session identifier and/or for transforming a user action into a request for establishing the communication.
The mobile device may be configured to run the app that runs on the mobile device, this app being according to any embodiment disclosed.
The mobile device may be configured for communicating the tare information associated with the weight of a chosen container to the weighing device according to any embodiment disclosed.

Everything that has been said above in relation to the first to fourth aspect of the present invention also applies to the mobile device according to the seventh aspect of the present invention. In particular, the mobile device may be according to any embodiment disclosed so far.

In particular, the mobile device may comprise any feature or combination of features disclosed so far and/or any feature configured for carrying out a function of the mobile device disclosed so far.

In an embodiment, the at least one of the following may apply:
The mobile device designed, in particular designed only, for a weighing and, as the case may be, pricing process. In other words, the mobile device is a store device and may be store-owned during its usage. This also means that the mobile device according to this embodiment is not a consumer electronics product, such as a smartphone.
The mobile device is a service device, in particular a service device as disclosed with respect to the third aspect of the invention.

In the following, the invention is explained in greater detail by way of example with reference to the drawings. In the drawings,

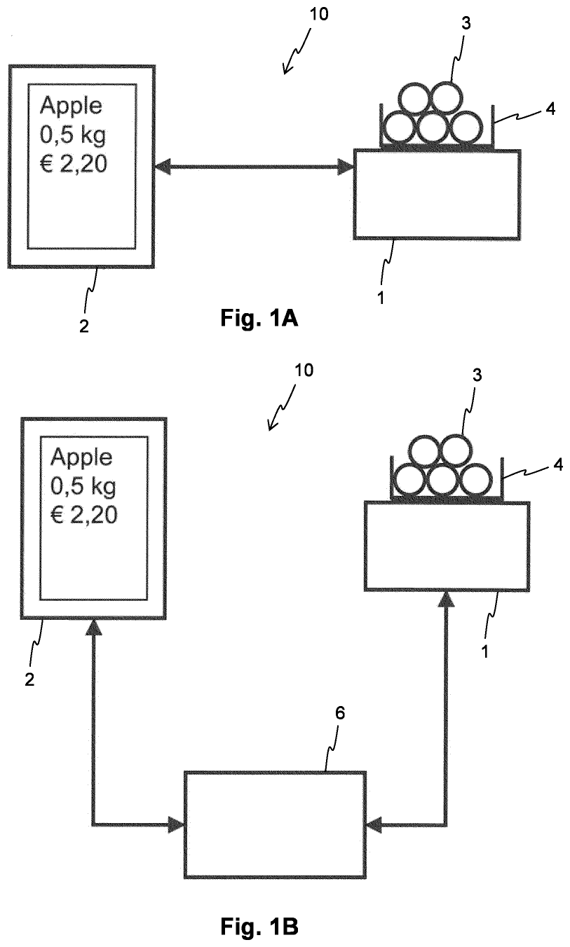

FIG. 1A is a schematic representation of a first embodiment of a system according to the fifth aspect of the present invention;

FIG. 1B is a schematic representation of a second embodiment of a system according to the fifth aspect of the present invention;

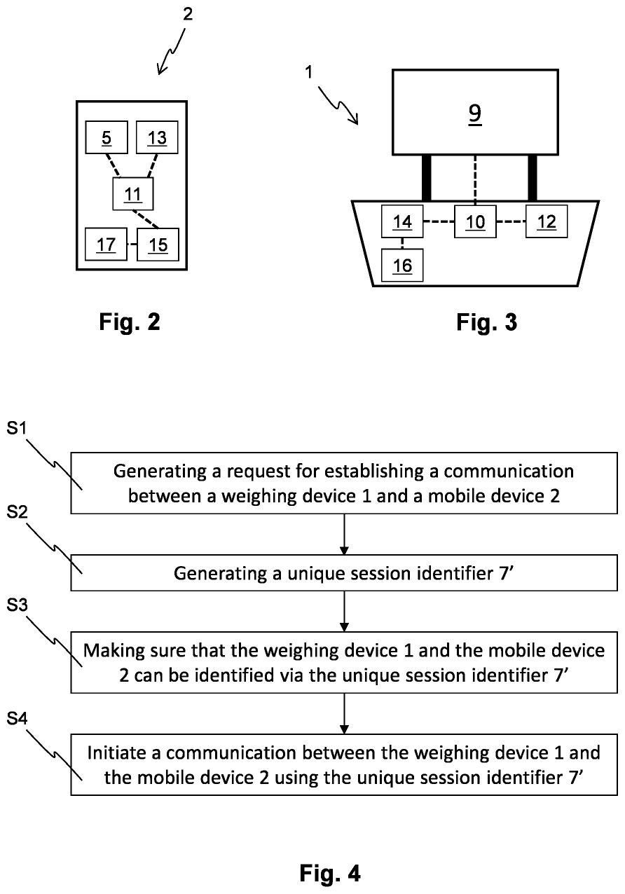

FIG. 2 is a schematic representation of an embodiment of a mobile device according to the seventh aspect of the present invention;

FIG. 3 is a schematic representation of an embodiment of a weighing device according to the sixth aspect of the present invention;

FIG. 4 is a flowchart showing basic steps of an embodiment of a method according to the first aspect of the invention;

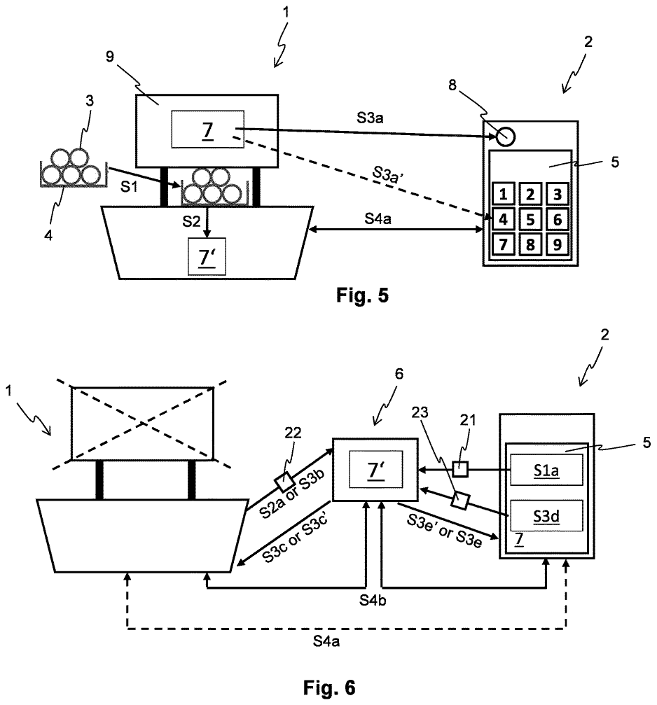

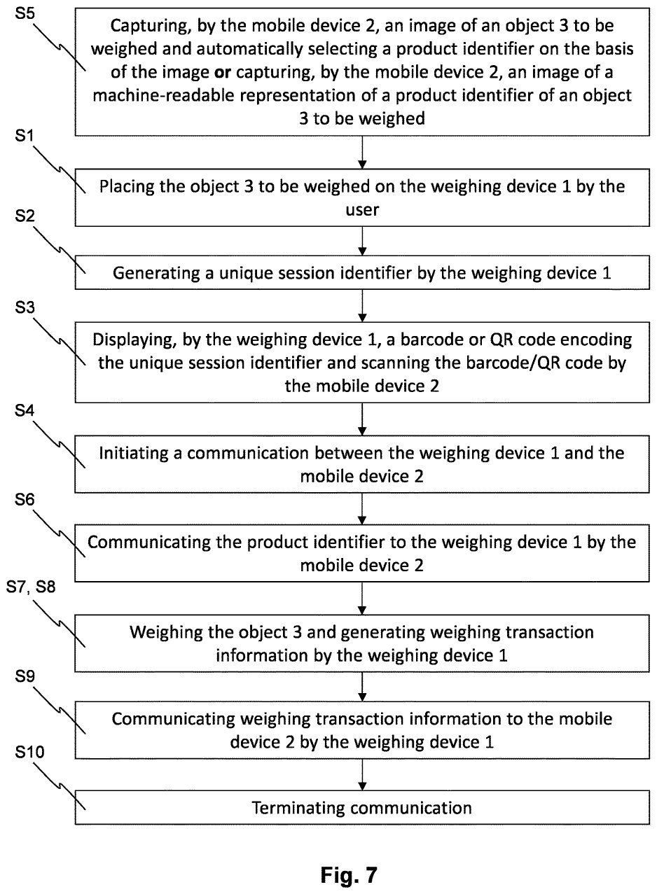

FIG. 5 is a schematic representation of an embodiment of a method according to the first aspect of the invention;

FIG. 6 is a schematic representation of another embodiment of a method according to the first aspect of the invention;

FIG. 7 is a flowchart of an embodiment of a method according to the second aspect of the present invention;

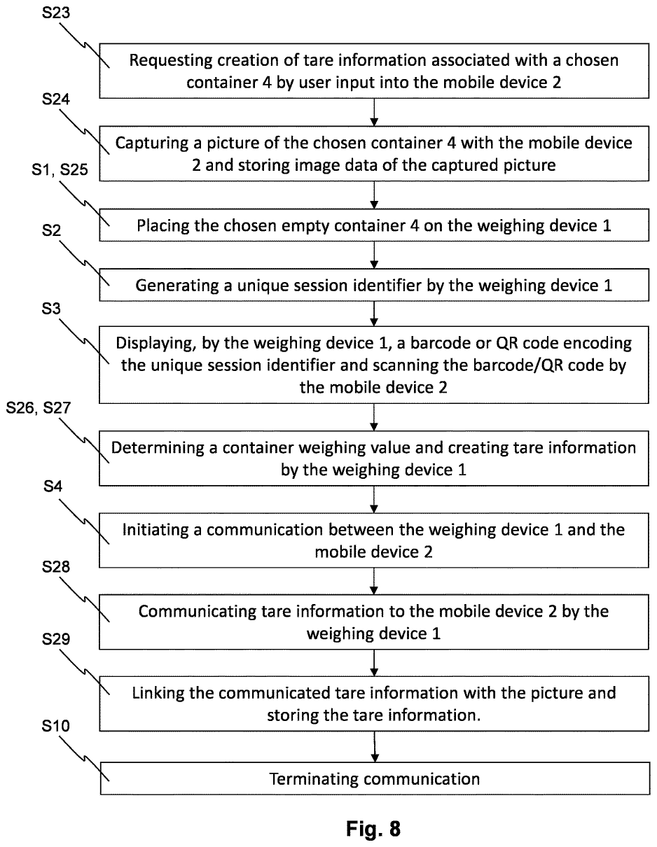

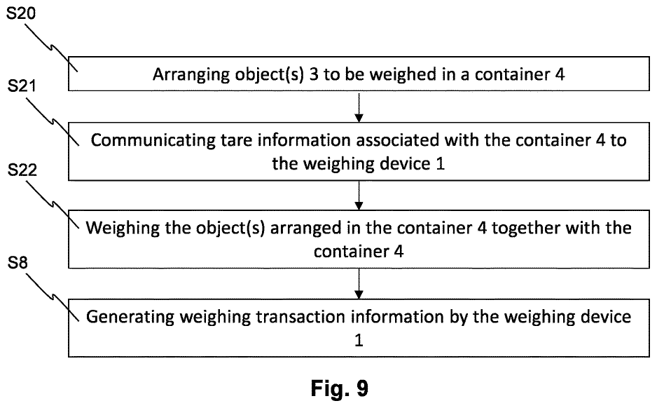

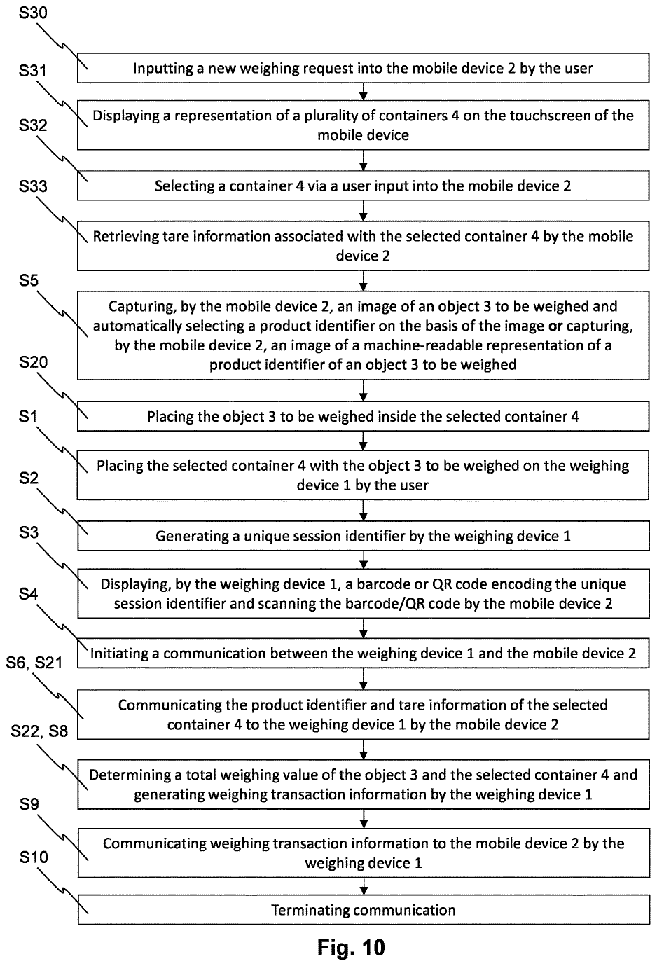

FIG. 8 is a flowchart of an embodiment of a method for generating tare information associated with a container, this tare information being used in methods according to FIG. 9 or 10, for example;

FIG. 9 is a flowchart showing basic steps of an embodiment of a method according to the secondary aspect of the invention; and

FIG. 10 is a flowchart of a further embodiment of a method according to the second aspect of the present invention, this embodiment comprising a method according to the first aspect of the invention and a method according to the secondary aspect of the invention.

FIG. 1A is a schematic representation of a first embodiment of a system 100 according to the fifth aspect of the present invention, this means of a system as used while carrying out at least one of a communication method between a weighing device 1 and a mobile device 2, in particular a communication method as disclosed with respect to FIGS. 4-6, a weighing method, in particular a weighing method as disclosed with respect to FIGS. 7-9, and a method for operating a weighing device, in particular as disclosed above. The system 100 comprises the weighing device 1 and the mobile device 2. In the embodiment shown, the weighing device 1 is a self-service scale arranged in a retail environment, e.g., a store selling food. The mobile device 2 may be carried by a user who has entered the store for shopping.

In the embodiment shown in FIG. 1A, the mobile device 2 is a smartphone having a touchscreen 5 and a camera 8 (not shown in FIG. 1A). The touchscreen 5 is an input/output means of the mobile device 2. In other word, the touchscreen 5 may be considered as a user interface of the mobile device 2.

On the mobile device 2, an app comprising a mobile device software module is installed which is executable by a mobile device processor (controller) 15 (not shown in FIG. 1A) of the mobile device 2. Optionally, a software module for decoding information encoded in a picture of a barcode or QR code and/or a software module for image recognition is installed on the mobile device 2 and executable by said mobile device processor 15.

The weighing device 1 comprises a load cell, a weighing device processor 14 (not shown in FIG. 1A) and a weighing device data carrier 16 (not shown in FIG. 1A) on which a weighing device software module is installed, said weighing device software module being executable by the weighing device processor 14. The weighing device software module and the mobile device software module carry instructions which, when the software modules are executed by the processor 14 of the weighing device 1, respectively by the processor 15 of the mobile device 2, cause a communication between the weighing device 1 and the mobile device 2 as explained in more detail below, in particular with respect to FIGS. 4-6. The weighing device 1 may further comprise display means 9 (not shown in FIG. 1A) for displaying a barcode or QR code.

In the exemplary embodiment shown in FIG. 1A, a container 4 carrying five apples (object 3 to be weighed) is placed on the weighing device 1.

In the embodiment shown in FIG. 1A, a direct communication between the weighing device 1 and the mobile device 2 is established as outlined below, in particular with respect to FIGS. 4-6. In an alternative second embodiment of the system 100 shown schematically in FIG. 1B, the communication between the weighing device 1 and the mobile device 2 is an indirect communication via a server 6. The weighing device 1 is connected with the server 6 via a wireless or wired connection. The mobile device 2 is connected with the server 6 via a wireless connection. In other words, the weighing device 1, the mobile device 2 and the server 6 are elements of a network that enables communication between the weighing device 1, the mobile device 2 and the server 6. However, before initiating a communication between the weighing device 1 and the mobile device 2 as explained below, in particular with respect to FIGS. 4-6, there is no communication between the weighing device 1 and the mobile device 2.

FIG. 2 is a schematic representation of an embodiment of a mobile device 2 according to the seventh aspect of the present invention, this means a mobile device 2 as used while carrying out at least one of a communication method between a weighing device 1 and a mobile device 2, in particular a communication method as disclosed with respect to FIGS. 4-6, a weighing method, in particular a weighing method as disclosed with respect to FIGS. 7-9, and a method for operating a weighing device, in particular as disclosed above.

The system 100 comprises usually a mobile device 2 as shown schematically in FIG. 2.

The mobile device 2 comprises a touchscreen 5, a communication module 11, a transceiver (transmitter-receiver module) 13, a mobile device processor (controller) 15, and a mobile device data carrier 17. It may comprise further a camera 8 (not shown FIG. 2).

The mobile device software module disclosed with respect to FIGS. 1A and 1B is installed on the mobile device data carrier 17 and executable by the mobile device processor 15.

As mentioned, the touchscreen 5 may be considered as a user interface. In particular, the touchscreen 5 provides a user interface for the communication method, the weighing method and/or the method for operating a weighing device when the mobile device software module is executed by the mobile device processor 15.

The communication module 11 is configured to enable the mobile device 2 to communicate with other devices, such as the weighing device 1 and/or the server 6. Therefore, the communication module 11 may comprise or control the transceiver 13 shown in FIG. 2. The transceiver 13 may comprise a NFC module or the mobile device may comprise a separate NFC module.

As pointed out with respect to the system 100 (FIGS. 1A and 1B), the mobile device 2 is designed for being carried by a user. In a preferred embodiment, the mobile device 2 is owned by the user. In particular, the mobile device 2 may be a smartphone. Alternatively, the mobile device 2 may be owned by the store in which the weighing device 1 is arranged and it may be provided to the user.

FIG. 3 is a schematic representation of an embodiment of a weighing device 1 according to the sixth aspect of the present invention, this means a weighing device 1 as used while carrying out at least one of a communication method between a weighing device 1 and a mobile device 2, in particular a communication method as disclosed with respect to FIGS. 4-6, a weighing method, in particular a weighing method as disclosed with respect to FIGS. 7-9, and a method for operating a weighing device, in particular as disclosed above.

The system 100 comprises usually a weighing device 1 as shown schematically in FIG. 3.

The weighing device 1 shown comprises display means 9, a communication module 10, a transceiver (transmitter-receiver module) 12, a weighing device processor (controller) 14, and a weighing device data carrier 16.

The weighing device software module disclosed with respect to FIGS. 1A and 1B is installed on the weighing device data carrier 16 and executable by the weighing device processor 14.

The display means 9 may be a display of the weighing device 1 and configured for displaying a barcode or QR code, for example. In particular, the information shown on the display means 9 may be determined by the weighing device software module when it is executed by the weighing device processor 14.

The communication module 10 is configured to enable the weighing device 1 to communicate with other devices, such as the mobile device 2 and/or the server 6. Therefore, the communication module 10 may comprise or control the transceiver 12 shown in FIG. 3. The transceiver 12 may comprise a NFC module or the weighing device 1 may comprise a separate NFC module.

As pointed out with respect to the system 100 (FIGS. 1A and 1B), the weighing device 1 may be a retail self-service scale.

FIG. 4 shows a flowchart of basics steps of an embodiment of a method according to the first aspect of the invention, this means of a communication method between a weighing device 1 and a mobile device 2. The communication method according to FIG. 1 comprises:
A step S1 of generating a request for establishing a communication between the weighing device 1 and the mobile device 2.
A step S2 of generating a unique session identifier 7′.
A step S3 of making sure that the weighing device 1 and the mobile device 2 can be identified via the unique session identifier 7′.
A step S4 of initiating a communication between the weighing device 1 and the mobile device using the unique session identifier 7′.

A communication method that is in agreement with the communication method shown in FIG. 4 may be implemented with the system 100 shown in FIG. 1A, 1B, 5 or 6.

The above-listed basic steps may be implemented differently depending on the embodiment of the communication method. In particular:
The step S1 of generating a request for establishing a communication between the weighing device 1 and the mobile device 2, may comprise or be initiated by:
   a step of placing an object 3, 4 on the weighing device;
   a step of establishing a near-field communication between the weighing device 1 and the mobile device; or
   a step of carrying out a user action on the mobile device.
The step S2 of generating a unique session identifier 7′ may be carried out by:
   the weighing device 1;
   the mobile device 1; or
   a server 6.
The step S3 of making sure that the weighing device 1 and the mobile device can be identified via the unique session identifier 7′ may comprise:
   a step of providing the unique session identifier 7′ to a communication module 10 of the weighing device 1 and to a communication module 11 of the mobile device 2; or
   a step of attributing the weighing device 1 and the mobile device 2 to the unique session identifier 7′.
The communication established by the step S4 of initiating a communication between the weighing device 1 and the mobile device using the unique session identifier 7′ may be
   a direct communication between the weighing device 1 and the mobile device; or
   an indirect communication between the weighing device 1 and the mobile device via a server 6.

According to a first preferred embodiment of a communication method that is in agreement with FIG. 4, the step S1 of generating a request for establishing a communication between the weighing device 1 and the mobile device 2 is initiated by the step of placing an object 3, 4 on the weighing device 1, the unique session identifier 7′ is generated by the weighing device 1, the step S3 of making sure that the weighing device 1 and the mobile device 2 can be identified via the unique session identifier 7′ comprises the step of providing the unique session identifier 7′ to a communication module 10 of the weighing device 1 and to a communication module 11 of the mobile device 2, and the communication established by the step S4 of initiating a communication between the weighing device 1 and the mobile device using the unique session identifier 7′ is a direct or indirect, preferably a direct, communication between the weighing device 1 and the mobile device.

According to a first variant of the first preferred embodiment, the step S3 of making sure that the weighing device 1 and the mobile device 2 can be identified via the unique session identifier 7′ comprises a step S3a of acquiring a picture of a representation 7 of the unique session identifier 7′ by the mobile device 2, wherein the representation 7 is displayed on display means 9 of the weighing device 1. In particular, this first variant may be as disclosed with respect to FIG. 5.

According to a second variant of the first preferred embodiment, the step S3 of making sure that the weighing device 1 and the mobile device 2 can be identified via the unique session identifier 7′ comprises a step of establishing a near-field communication (NFC) between the weighing device 1 and the mobile device 2, and transferring a copy of the unique session identifier 7′ from the weighing device 1 to the mobile device 2 via the established near-field communication.

According to a second preferred embodiment of a communication method that is in agreement with FIG. 4, the step S1 of generating a request for establishing a communication between the weighing device 1 and the mobile device 2 is initiated by the step of establishing a near-field communication between the weighing device 1 and the mobile device 2, the unique session identifier 7′ is generated by the weighing device 1 or the mobile device 2, the step S3 of making sure that the weighing device 1 and the mobile device 2 can be identified via the unique session identifier 7′ comprises a step of providing the unique session identifier 7′ to a communication module 10 of the weighing device 1 and to a communication module 11 of the mobile device 2, wherein a copy of the unique session identifier 7′ is provided to the communication module of the device that did not generate the unique session identifier 7′ via the established near-field communication, and the communication established by the step S4 of initiating a communication between the weighing device 1 and the mobile device using the unique session identifier 7′ is a direct or indirect, preferably a direct, communication between the weighing device 1 and the mobile device 2.

Other embodiments of the communication method that are in agreement with FIG. 4 are conceivable, for example the embodiment of the communication method disclosed with respect to FIG. 6.

FIG. 5 shows a first exemplary embodiment of a communication method according to FIG. 4. In this embodiment, the step S1 of generating a request comprises, in particular is initiated, by the user placing an object 3, 4 on the weighing device 1. The step S2 of generating a unique session identifier 7′ is then carried out by the weighing device 1, and the step S3 of making sure comprises a step in which the weighing device 1 provides the unique session identifier 7′ to the mobile device 2. This step of providing comprises, in the embodiment shown in FIG. 5, displaying a representation 7 of the unique session identifier 7′ on the display means 9 of the weighing device 1. The step S3 of making sure comprises further, in the embodiment shown in FIG. 5, a step S3a of acquiring a picture of the representation 7 by the mobile device 2. Alternatively, the step S3 of making sure may comprise a step S3a′ of transfer manually the displayed representation 7 of the unique session identifier 7′ to the mobile device 2, for example by the representation 7 being a numerical code and by entering this code on the touchscreen 5 of the mobile device 2. After providing the unique session identifier 7′ to both the communication module 10 of the weighing device 1 and the communication module 11 of the mobile device 2, the step S4 of initiating a communication is a step S4a of establishing a direct communication between the weighing device 1 and the mobile device 2.

FIG. 6 shows a second exemplary embodiment of a communication method according to FIG. 4. In this embodiment, a remote device 6, such as the server 6 disclosed with respect to FIG. 1B, is involved in the communication method.

In principle, the step S1 of generating a request for establishing a communication between the weighing device 1 and the mobile device 2, and the step S2 of generating a unique session identifier may be according to any embodiment disclosed with respect to FIGS. 4 and 5. However, in the embodiment disclosed with respect to FIG. 6, the step S1 of generating a request for establishing a communication between the weighing device 1 and the mobile device 2 comprises either the step of placing an object 3, 4 on the weighing device 1, or the step of carrying out a user action on the mobile device, namely a step S1a of inputting a user input on the mobile device 2, wherein this user inputs indicates that the user wants to start a weighing process. If the step S1 of generating a request for establishing a communication between the weighing device 1 and the mobile device 2 comprises the step of placing an object 3, 4 on the weighing device 1, the step S2 of generating a unique session identifier is either carried out by the weighing device 1, or the weighing device 1 initiates generation of the unique session identifier 7′ by the remote device (step S2a in FIG. 6). If the step S1 of generating a request for establishing a communication between the weighing device 1 and the mobile device 2 comprises the step S1a of inputting a user input on the mobile device 2, the step S2 of generating a unique session identifier is either carried out by the mobile device 1, or the mobile device 1 initiates generation of the unique session identifier 7′ by the remote device 6.

The step S3 of making sure that the weighing device 1 and the mobile device 2 can be identified via the unique session identifier comprises then, according to the embodiment shown inf FIG. 6, providing the unique session identifier 7′ by the remote device 6 only to the “right” weighing device 1 and only to the “right” mobile device 2, or attributing by the remote device 6 the “right” weighing device 1 only and the “right” mobile device 2 only to the unique session identifier 7′. In the embodiment shown in FIG. 6, this is done by executing an app by the processor 14 of the mobile device 2. The app guides the user in a manner that the device that did neither initiate the generation of the unique session identifier 7′ by the remote device 6 nor generated the unique session identifier 7′ can be identified by considering the time of events registered by the remote device 6. The device that initiated generation of the unique session identifier 7′ by the remote device 6 or that generated the unique session identifier 7′ can be identified easily by the remote device 6 and the unique session identifier 7′ can be provided to it or it can be attributed to the unique session identifier 7′ in a straight forward manner.

In the embodiment shown in FIG. 6, the app enables a user input S1a on the mobile device 2, this user input indicating that the user wants to start a weighing process. The user input causes a first message 21 that is representative for the user's intention to start a weighing process and that is register by the remote device 6.

In reaction to this user input, the app may prompt the user to place an object 3, 4, that may be a first object of a plurality of objects, on the weighing device 1. Placing an object on the weighing device 1 causes a second message 22 that is representative for this event and that is registered by the remote device 6.

According to a first variant of the embodiment shown in FIG. 6, this variant being shown in FIG. 6, the weighing device 1 initiates generation of the unique session identifier 7′ by the remote device 6 after placing the object 3, 4 on the weighing device 1, or the weighing device 1 generates the unique session identifier 7′ after placing the object 3, 4 on the weighing device 1 and provides it to the remote device 6.

In the former case, the second message 22 is or comprises the request for establishing a communication. In other words, the step S2 of generating a unique session identifier comprises a step S2a of initiating generation of a unique session identifier by the weighing device 1 by sending a message and the remote device 6 receiving this message, in particular the second message 22 that is or comprises the request for establishing a communication. Yet in other words, the step S2 of generating a unique session identifier comprises a step S2a of transferring a message, in particular the second message 22 that is or comprises the request for establishing a communication, from the weighing device 1 to the remote device 6.

In the latter case, the second message 22 is or comprises the unique session identifier. In other words, the step S3 of making sure that the weighing device 1 and the mobile device 2 can be identified via the unique session identifier comprises a step S3b of transferring a message, in particular the second message 22 that is or comprises the unique session identifier, from the weighing device 1 to the remote device 6.

In embodiments of the first variant, it is-as mentioned-the placement of an object 3, 4 on the weighing device 1 that generates the request for establishing a communication, wherein the object may be a first object of a plurality of objects and wherein the user may be prompt by the app to place the object on the weighing device 1. In other words, the step S1 of generating a request comprises, in particular is initiated, by the user placing an object 3, 4 on the weighing device 1, again.

As soon as the unique session identifier is available to the remote device 6, a copy of the unique session identifier 7′ is transferred from the remote device 6 to the weighing device 1 (in particular in embodiments in which the weighing device 1 does not yet have the unique session identifier, this means in embodiments of the “former case” in which the unique session identifier is generated by the remote device 6), or the weighing device is attributed to the unique session identifier (may happen in both the “former case” and “latter case”). In other words, the step S3 of making sure that the weighing device 1 and the mobile device 2 can be identified via the unique session identifier comprises a step S3c of transferring a copy of the unique session identifier from the remote device 6 to the weighing device 1, or a step S3c′ of attributing the weighing device 1 that sent the second message 22 to the unique session identifier.

Further, according to the first variant shown in FIG. 6, the app prompts the user to confirm that an object 3, 4 was placed on the weighing device 1. In other words, the step S3 of making sure that the weighing device 1 and the mobile device 2 can be identified via the unique session identifier 7′ comprises a step S3e of receiving a user confirmation that an object was placed on the weighing device 1. This confirmation causes a third message 23 that is registered by the remote device 6. Reception of the third message 23 by the remote device 6 allows the remote device 6 to identify the “right” mobile device. The “right” mobile device is the mobile device 2 that sent the first message 21 and the third message 23 in such a chronological sequence that the second message 22 is between the first message 21 and third message 23. Identification of the “right” mobile device may comprise an additional validation step, in particular if there is any doubt that the “right” mobile device was identified. The validation step may comprise or consist of a simple confirmation by the user on the mobile device 2. In particular, the confirmation is given during execution of the app by the processor 14 of the mobile device 2. Alternatively or in addition, the validation step may comprise use of NFC, user position recognition etc.

As soon as the “right” mobile device is identified, the unique session identifier 7′ or a copy thereof is transferred from the remote device 6 to the mobile device 2, or the mobile device 2 is attributed to the unique session identifier. In other words, the step S3 of making sure that the weighing device 1 and the mobile device 2 can be identified via the unique session identifier comprises a step S3e of transferring the unique session identifier or a copy thereof from the remote device 6 to the mobile device 2, or a step S3e′ of attributing the mobile device 2 to the unique session identifier.

In embodiments in which the weighing device 1 and the mobile device 2 are attributed to the (same) unique session identifier, an indirect communication between the weighing device 1 and the mobile device 2 can be established as soon as the weighing device 1 and the mobile device 2 are attributed to the (same) unique session identifier. In other words, the step S4 of initiating a communication between the weighing device 1 and the mobile device 2 using the unique session identifier is or comprises a step S4b of establishing an indirect communication between the weighing device 1 and the mobile device 2 via the remote device 6.

In embodiments in which the weighing device 1 and the mobile device 2 have the (same) unique session identifier, a direct communication between the weighing device 1 and the mobile device 2 can be established as soon as the weighing device 1 and the mobile device 2 have the (same) unique session identifier. In other words, the step S4 of initiating a communication between the weighing device 1 and the mobile device 2 using the unique session identifier is or comprises a step S4a of establishing a direct communication between the weighing device 1 and the mobile device 2. Alternatively, the communication between the weighing device 1 and the mobile device may be an indirect communication via the remote device 6, if the remote device 6 (still) has the (same) unique session identifier.

According to a second variant that is not shown in FIG. 6 in an explicit manner, the mobile device 2 initiates generation of the unique session identifier 7′ by the remote device 6, or the mobile device 2 generates the unique session identifier 7′ and provides it to the remote device 6.

In the former case, the first message 21 is or comprises the request for establishing a communication. In other words, the step S2 of generating a unique session identifier comprises a step of initiating generation of a unique session identifier by the mobile device 2 sending a message and the remote device 6 receiving this message, in particular the first message 21 that is or comprises the request for establishing a communication. Yet in other words, the step S2 of generating a unique session identifier comprises a step of transferring a message, in particular the first message 21 that is or comprises the request for establishing a communication, from the mobile device 2 to the remote device 6.

In the latter case, the first message 21 is or comprises the unique session identifier. In other words, the step S3 of making sure that the weighing device 1 and the mobile device 2 can be identified via the unique session identifier comprises a step of transferring a message, in particular the first message 21 that is or comprises the unique session identifier, from the mobile device 2 to the remote device 6.

In embodiments of the second variant, it is-as mentioned-the step S1a of the user inputting on the mobile device 2 an indication for the user's intention to start a weighing process that generates the request for establishing a communication. In other words, the step S1 of generating a request comprises, in particular is initiated, by a user action carried out on the mobile device 2.

As soon as the unique session identifier is available to the remote device 6, a copy of the unique session identifier is transferred from the remote device 6 to the mobile device 2 (in particular in embodiments in which the mobile device 2 does not yet have the unique session identifier, this means in embodiments of the “former case” in which the unique session identifier is generated by the remote device 6), or the mobile device 2 is attributed to the unique session identifier (may happen in both the “former case” and “latter case”). In other words, the step S3 of making sure that the weighing device 1 and the mobile device 2 can be identified via the unique session identifier comprises a step of transferring a copy of the unique session identifier from the remote device 6 to the mobile device 2, or a step of attributing the mobile device 2 that sent the first message 21 to the unique session identifier.

Further, according to the second variant not shown in FIG. 6, the app prompts the user to confirm that an object 3, 4 was placed on the weighing device 1. In other words, the step S3 of making sure that the weighing device 1 and the mobile device 2 can be identified via the unique session identifier comprises a step of receiving a user confirmation that an object was placed on the weighing device 1. This confirmation causes a third message 23 that is registered by the remote device 6. Reception of the third message 23 by the remote device 6 allows the remote device 6 to identify the “right” weighing device. The “right” weighing device is the weighing device 1 that sent the second message 22 between the first message 21 and third message 23. Identification of the “right” weighing device may comprise an additional validation step, in particular if there is any doubt that the “right” weighing device was identified. The validation step may comprise or consist of a simple confirmation by the user on the mobile device 2. In particular, the confirmation is given during execution of the app by the processor 14 of the mobile device 2. Alternatively or in addition, the validation step may comprise use of NFC, user position recognition etc.

As soon as the “right” weighing device is identified, the unique session identifier or a copy thereof is transferred from the remote device 6 to the weighing device 1, or the weighing device 1 is attributed to the unique session identifier. In other words, the step S3 of making sure that the weighing device 1 and the mobile device 2 can be identified via the unique session identifier comprises a step of transferring the unique session identifier or a copy thereof from the remote device 6 to the weighing device 1, or a step of attributing the weighing device 1 to the unique session identifier.

In embodiments in which the weighing device 1 and the mobile device 2 are attributed to the (same) unique session identifier, an indirect communication between the weighing device 1 and the mobile device 2 can be established as soon as the weighing device 1 and the mobile device 2 are attributed to the (same) unique session identifier. In other words, the step S4 of initiating a communication between the weighing device 1 and the mobile device 2 using the unique session identifier is or comprises a step S4b of establishing an indirect communication between the weighing device 1 and the mobile device 2 via the remote device 6.

In embodiments in which the weighing device 1 and the mobile device 2 have the (same) unique session identifier, a direct communication between the weighing device 1 and the mobile device 2 can be established as soon as the weighing device 1 and the mobile device 2 have the (same) unique session identifier. In other words, the step S4 of initiating a communication between the weighing device 1 and the mobile device 2 using the unique session identifier is or comprises a step S4a of establishing a direct communication between the weighing device 1 and the mobile device 2. Alternatively, the communication between the weighing device 1 and the mobile device 2 may be an indirect communication via the remote device 6, if the remote device 6 (still) has the (same) unique session identifier.

Independent of the concrete realization of the communication method according to the second exemplary embodiment, the step of confirming that an object 3, 4 was placed on the weighing device 1 may be replaced by another user action carried out on the mobile device 2 and that is indicative for an object 3, 4 having been placed on the weighing device 1. Initiation of transmission of a product identifier or a container selection are examples of such other user interactions.

In particular in embodiments in which a communication method according to the second exemplary embodiment is part of a weighing method, the weighing method may further comprise a step of displaying, for example on the display means 9 of the weighing device 1 or on the mobile device 2, information that allows identification of the object 3, the measured weight of the object, and the corresponding price to the user, wherein this object is or will be transferred to a virtual basket of the user at the displayed corresponding price.

FIG. 7 is a flowchart of an exemplary embodiment of the method according to the second aspect of the present invention, this means of a weighing method. The method shown may be implemented with the system 100 shown in FIG. 1A, 1B, 5 or 6. For illustrative purposes, it is assumed that the weighing device 1 is arranged inside a store. A user carrying a smartphone which is the mobile device 2 enters the store. In the store, there are products which are sold by weight. These products are called objects to be weighed in the following.

Inside the store, the user decides to purchase a certain product which is sold by weight, e.g., they decide to buy five apples. The user takes their smartphone and opens the app installed on the smartphone, this means executes the app by the processor 14 of the mobile device 2.

The app assists the user to receive for each product that the user intends to buy by weight the corresponding product identifier.

In the embodiment shown in FIG. 7, the mobile device prompts the user to capture, by the mobile device 2, an image of the product 3 to be purchased, wherein the app is configured to select automatically the corresponding product identifier on the basis of the image. Alternatively, the app prompts the user to capture, by the mobile device 2, an image of a machine-readable representation (identifier) of the product identifier of said product 3, e.g., a barcode or QR code encoding said product identifier. In other words, the weighing method comprises a step S5 of capturing, by the mobile device 2, an image of the product 3 to be purchased and automatically selecting the corresponding product identifier on the basis of the image or of capturing, by the mobile device 2, an image of a machine-readable representation (identifier) of the product identifier of said product 3, e.g., a barcode or QR code encoding said product identifier.

The product identifier is any information which allows to uniquely identify the associated object. For example, the product identifier may be a string of numbers and/or letters.

When the mobile device 2 is configured to prompt the user to capture an image of a machine-readable representation of the product identifier of the object 3 to be weighed, the machine-readable representation of the product identifier, such as a barcode or QR code, may be attached on or in the vicinity of the associated product, e.g., on a shelf or basket where the product is stored.

When the mobile device 2 is configured to prompt the user to capture an image of the object to be weighed, a data table comprising for each of the plurality of available objects to be weighed an associated product identifier is accessible to the mobile device 2, e.g., it may be stored on the mobile device 2 or remotely. The mobile device 2 selects automatically the product identifier of the object 3 on the basis of the picture by image recognition from the data table.

The mobile device 2 prompts then the user to place the object 3 to be weighed on the weighing device 1, e.g. by displaying said prompt on the touchscreen. Consequently, the weighing method comprises a step of placing the object 3 to be weighed on the weighing device. In the embodiment shown in FIG. 7, it is again this step of placing that initiates the step S1 of generating a request for establishing a communication between the weighing device 1 and the mobile device 2.

In response to placing the object 3 on the weighing device 1, the weighing device 1 generates a unique session identifier, this means the weighing method comprises the step S2 of generating a unique session identifier, wherein the unique session identifier is generated by the weighing device 1, in the embodiment shown in FIG. 7.

The weighing device 1 encodes then said unique session identifier in a barcode or QR code and displays the barcode or QR code 7 on display means 9 of the weighing device 1, after which the user scans the displayed barcode/QR code with the mobile device 2 by taking a picture with the camera of the mobile device 2. The mobile device 2 then retrieves the unique session identifier encoded in said barcode/QR code, so that the unique session identifier is communicated to the mobile device 2. In other words, the step S3 of making sure that the weighing device 1 and the mobile device 2 can be identified via the unique session identifier comprises a substep of displaying, by the weighing device 1, a barcode or QR code 7 encoding the unique session identifier, and a substep of scanning the displayed barcode/QR by the mobile device.

After communicating the unique session identifier to the mobile device, the weighing method comprises the step S4 of initiating a communication between the weighing device 1 and the mobile device 2, wherein the right pairing partners are the weighing device 1 and the mobile device 2 having this (same) unique session identifier.

Upon the initiation of the communication, the mobile device 2 communicates the product identifier of the object 3 to be weighed to the weighing device 1. In other words, the weighing method comprises a step S6 of the mobile device 2 communicating the product identifier of the object 3 to be weighed to the weighing device 1.

Once the weighing device 1 has obtained the product identifier, the weighing device 1 generates weighing transaction information on the basis of the product identifier, and a measured weighing value of the object 3 placed on the weighing device 1. In particular, the weighing transaction information comprises the weighing value of the object 3 and a price. The price is usually calculated by the weighing device 1 on the basis of the measured weighing value and a price per unit weight of the object which may be stored in a data table, preferably on the weighing device 1 or remotely, and which may associate the product identifier with the price per unit weight of the object.

In other words, the weighing method comprises a step S7 of weighing the object 3 placed on the weighing device 1 and a step S8 of generating weighing transaction information. When the step S7 of weighing the object 3 is carried out is of no importance as long as the measured weighing value is available for carrying out the step S8 of generating weighing transaction information.

The weighing transaction information is communicated then to the mobile device 2 by the weighing device 1 in a step S9 of communicating the weighing transaction information to the mobile device 2 by the weighing device 1, wherein this communication is carried out using the communication initiated in the step S4 of initiating a communication between the weighing device 1 and the mobile device 2.

After communicating the weighing transaction information, the communication initiated in the step S4 of initiating a communication between the weighing device 1 and the mobile device 2 is terminated in a step S10 of terminating communication. Terminating may be immediately after sending the weighing transaction information, preferably after receiving of the weighing transaction information by the mobile device 2, or even more preferable after the weighing device 1 has received a confirmation of receipt by the mobile device 2, wherein the confirmation of receipt may comprise the information that there are further objects to be weighed. In case there are further objects to be weighed, the step S10 of terminating communication may be postponed until there are no further objects to be weighed or a user input indicated that the user wants to stop the communication and/or the weighing process.

FIG. 8 is a flowchart of an embodiment of a method for generating tare information associated with a container 4, this tare information being used in embodiments of weighing methods, for example weighing methods according to FIG. 9 or 10.

If method steps according to FIG. 8 are used in a weighing method, for example a weighing method according to FIG. 9 or 10, these steps are integrated in a user's shopping process. In particular, these method steps may be carried out prior to arranging the object(s) (product(s)) to be weighed on the weighing device 1.

The method steps are usually carried out by the user interacting with an app that runs on the mobile device 2, in particular on the user's mobile device 2. This app may be the app that is used in at least one of the communication method, in particular as disclosed with respect to FIGS. 1A, 1B, 4, 5, or 6, and the weighing method, in particular as disclosed with respect to FIG. 7, 9 or 10. In particular, the app guides the user through related method steps.

The container 4 for which tare information is provided is a container owned by the user, wherein the user intends to use this container during shopping, in particular for arranging therein a product 3 that the user wants to buy and that needs to be weighed, in particular bulk goods (bulk items, bulk food), produce, unpackaged products etc.

It is evident from the following, that the method for generating tare information according to FIG. 8 comprises a specific embodiment of the communication method. It goes without saying that other embodiments of the communication method work as well as the specific embodiment disclosed with respect to FIG. 8 and that one of these other embodiments may be integrated in the method for generating tare information, instead.

A method for generating tare information that is in agreement with the method shown in FIG. 8 may be implemented with the system 100 shown in FIG. 1A, 1B, 5 or 6.

In the embodiment shown in FIG. 8, the method for generating tare information associated with a container 4, comprises:
A step S23 of requesting creation of tare information associated with the container 4. This request is created by a user input into the mobile device 2, for example by tipping on a corresponding icon displayed on the touchscreen 5 of the mobile device 2 when the app is running.
A step S24 of capturing a picture of the container 4 for which tare information needs to be created and of storing image data of the captured picture. This step S24 of capturing a picture is carried out by the user using a camera 8 of the mobile device 2. The image data is usually stored on the mobile device 2. The step S24 of capturing a picture and of storing image data is controlled by the app running on the mobile device 2. In particular, the mobile device 2 may prompt the user to capture a picture of the container 4 in response to said request.
The step of capturing a picture and of storing image data is not mandatory for a method for generating tare information. Any alternative step that allows for later recognition and selection of tare information created for a specific container 4 is sufficient within a method for generating tare information.
A step S25 of placing the empty container 4 on the weighing device 1. The mobile device may prompt the user to place the empty container 4 on the weighing device 1 after capturing the picture and storing image data.
Placing the empty container 4 on the weighing device 1 may be, and usually is, the event that causes generation of a request for establishing a communication between the weighing device 1 on which the empty container 4 was placed and the mobile device 2 of the user that wants to create tare information associated with this container 4. In other words, the step S25 of placing the empty container 4 on the weighing device 1 may be considered as the step S1 of generating a request for establishing a communication between the weighing device 1 and the mobile device 2.
A step S2 of generating a unique session identifier. As disclosed with respect to FIGS. 4-7, a unique session identifier is generated in reaction to the step S1 of generating a request for establishing a communication. In other words, the method for generating tare information comprises a step S2 of generating a unique session identifier, wherein the unique session identifier, in the exemplary embodiment disclosed with respect to FIG. 8, is generated by the weighing device 1 in reaction to the step S25 of placing the empty container 4 on the weighing device 1.
A step S3 of making sure that the weighing device 1 and the mobile device 2 can be identified via the unique session identifier. In the embodiment shown in FIG. 8, this is done as disclosed with respect to FIG. 5 or 7, this means by displaying on display means 9 of the weighing device 1 a barcode or QR code that encodes the unique session identifier and by scanning the barcode or QR code using the mobile device 2. The mobile device 2 retrieves the unique session identifier encoded in the barcode/QR code. Thereby, the unique session identifier is communicated to the mobile device.
A step S26 of determining, by the weighing device 1, a container weighing value, in particular the actual weight of the empty container 4, for example in grams (g) or kilograms (kg), and a step S27 of creating tare information associated with the container 4 by the weighing device 1 and on the basis of the determined container weighing value. The tare information may include the container weighing value.
A step S4 of initiating a communication between the weighing device 1 and the mobile device using the unique session identifier. In the embodiment of FIG. 8, this step is as disclosed with respect to FIG. 4, 5 or 7. The communication may be initiated and established in an automated manner after the scanning the barcode or QR code using the mobile device 2.
A step S28 of communicating the tare information to the mobile device via the established communication between the weighing device 1 and the mobile device 2.
A step S29 of linking, on the mobile device 2, the communicated tare information with the picture captured in the step S24 of capturing a picture of the container 4 (or with any other identifier that allows for later recognition and selection of tare information created for a specific container 4) and of storing the tare information, preferably on the mobile device 2. Thereby, the tare information will be available, in particular can be provided, in future weighing processes in a user-friendly manner, for example by tipping on an icon showing the picture or the identifier, in particular during a weighing or shopping process that is guided by the app.
A step S10 of terminating the communication between the weighing device 1 and the mobile device 2, for example as disclosed with respect to FIG. 7. Again, the step S10 of terminating may be carried out only if there is no object (product) to be weighed or if a user input indicates that user wants to stop the communication.

The method for generating tare information may be carried out for different containers 4. Thereby a tare information table may be generated from which the user can select in an easy and user-friendly manner the container the user intends to use in an actual weighing process. The app that runs on the mobile device may then provide the tare information associated with the selected container in an automated manner during the actual weighing process.

FIG. 9 is a flowchart showing basic steps of an embodiment of a method according to the secondary aspect of the invention, this means of a weighing method that is able to contribute to waste reduction by integrating a customer container in a weighing process. The embodiment shown does not comprise steps of the communication method, for example as shown with respect to FIGS. 4-6, or steps shown with respect other weighing methods, such as the weighing methods shown with respect to FIG. 7 or 10. However, the weighting method according to the secondary aspect may comprise such steps, in embodiments.

The weighing method may be, and usually is, carried out by the user interacting with an app that runs on the mobile device 2, in particular on the user's mobile device 2. This app may be the app that is used in at least one of the communication method, in particular as disclosed with respect to FIGS. 1A, 1B, 4, 5, or 6, the weighing method, in particular as disclosed with respect to FIG. 7 or 10, and the method for generating tare information, in particular as disclosed with respect to FIG. 8. In particular, the app guides the user through related method steps.

A weighing that is able to contribute to waste reduction and that is in agreement with the method shown in FIG. 9 may be implemented with the system 100 shown in FIG. 1A, 1B, 5 or 6.

The basic steps of the embodiment of the weighing method that is able to contribute to waste reduction according to FIG. 9 are:
A step S20 of arranging the object(s) (product(s)) 3 to be weighed in a container 4. The container is a user owned container for which tare information is available. If more than one object is arranged in the container—what is usually the case—these objects are of the same kind. For example, the objects are a plurality of (same) apples as shown with respect to FIGS. 1A and 1B, a plurality of the same bulk good, produce, unpacked product etc.
In case tare information of the container 4 is not available, the weighing method according to FIG. 9 may comprise a method of generating such tare information, for example by comprising a method as disclosed with respect to FIG. 8.
The tare information may be or comprise the weight of the empty container and/or the information that the weight of the container is zero or close to zero.
A step S21 of communicating tare information associated with the container 4 to the weighing device 1.
In embodiments, the tare information is communicated using a communication established by a communication method as disclosed with respect to FIGS. 4-6. This also means that, in embodiments, the weighing method according to FIG. 9 may comprise the communication method, for example a communication method according to FIGS. 4-6.
As disclosed with respect to FIG. 8, the tare information is stored on the mobile device 2 in a preferred embodiment. In this embodiment, the tare information is communicated, using a direct or indirect communication, from the mobile device 2 to the weighing device 1.
A step S22 of weighing the object(s) 3 arranged in the container 4 together with the container 4. This step S22 of weighing is carried out by the weighing device 1 with which a communication was established and to which the tare information associated with the container 4 was communicated. The output of this step S22 of weighing is a total weighing value for the object(s) 3 and the container 4 in which the object(s) 3 are arranged.
A step S8 of generating weighing transaction information by the weighing device 1. In the embodiment according to FIG. 9, the weighing transaction information comprises the weight of the object(s) 3 arranged in the container 4 (without the weight of the container), the price of the object(s) arranged in the container, and, optionally, the price per unit weight of the object(s) arranged in the container. The weight of the object(s) 3 arranged in the container 4 is generated based on the total weighing value and the tare information communicated to the weighing device 1. In particular, the weight of the container, this weight being comprised in the tare information, is subtracted from the total weighing value determined in the step S22 of weighing the object(s) 3 arranged in the container 4 together with the container 4. As mentioned, the objects arranged in the container are of the same kind if more than one object is arranged in the container. Therefore, it is possible to retrieve the price per unit weight of the objects, this means of the (single) kind of objects, arranged in the container, and to calculate the price of the objects arranged in the container using the determined weight of these objects and the retrieved price per unit weight. The price per unit weight may be retrieved after providing a product identifier, for example as disclosed with respect to FIG. 7 (steps S5 and S6, in particular).

When integrated in a purchase process, the weighing method according to FIG. 9 may comprise further a step S9 of communicating the generated weighing transaction information to the mobile device, for example as disclosed with respect to FIG. 7. The generated weighing transaction information may be communicated using the communication established for the step S21 of communicating tare information associated with the container 4 to the weighing device 1.

When integrated in a purchase process, the weighing method according to FIG. 9 may comprise further a step S10 of terminating the communication between the weighing device 1 and the mobile device 2. This step S10 of terminating may be configured as disclosed with respect to FIG. 7, for example.

FIG. 10 is a flowchart of a further exemplary embodiment of the method according to the second aspect of the present invention, this means of a weighing method. The method shown is similar to the method shown in FIG. 7 but comprises further a method according to the first aspect of the invention, this means a communication method between a weighing device 1 and a mobile device 2, for example as disclosed with respect to FIGS. 4-6, and a method according to the secondary aspect of the invention, this means steps that enable the method to contribute to waste reduction, for example as disclosed with respect to FIG. 9. The weighting method shown in FIG. 10 may be implemented with the system 100 shown in FIG. 1A, 1B, 5 or 6. For illustrative purposes, it is assumed that the weighing device 1 is arranged inside a store. A user carrying a smartphone which is the mobile device 2 enters the store. In the store, there are products which are sold by weight. These products are called objects to be weighed in the following.

Inside the store, the user decides to purchase a certain product which is sold by weight, e.g., they decide to buy five apples. The user takes their smartphone and opens the app installed on the smartphone.

The app guides the user through the weighing process of the certain product that is sold by weight and that the user wants to purchase.

First, the user inputs a new weighing request into the mobile device 2, for example by touching a certain icon displayed on the touchscreen 5 of the mobile device. In other words, the weighing method comprises a step S30 of inputting, by the user, a new weighing request into the mobile device 2.

In response to this request, the mobile device 2 displays a representation of a plurality of containers on the touchscreen 5 of the mobile device 2, for example, as an arrangement of icons which may comprise pictures of the respective containers. In other words, the weighing method comprises as step S31 of displaying a representation of a plurality of containers 4 on the touchscreen of the mobile device. The plurality of containers may comprise containers available at the store, like plastic or paper containers as well as the user's own containers. The representation and information linked to the plurality of containers may be generated as disclosed with respect to FIG. 8. The representation may represent the tare information table disclosed with respect to FIG. 8.

The user decides that they will use a certain container 4 for packaging and/or transporting the product. Then, in a step S32 of selecting a container 4 via a suer input into the mobile device 2, the user inputs the selection of the container in the mobile device 2, e.g., by touching the respective icon displayed on the touchscreen 5.

In response to this user input, the mobile device 2 retrieves tare information associated with the selected container, this means the method comprises a step S33 of retrieving tare information associated with the selected container by the mobile device 2. The tare information comprises a container weighing value of the selected container. In the embodiment of FIG. 10, the tare information is stored on a data carrier 17 of the mobile device 2. Ways how to generate and retrieve said tare information are explained with respect to FIG. 8.

Then, the mobile device 2 prompts the user to capture, by the mobile device, an image of the product 3 to be purchased, wherein the app is configured to select automatically the corresponding product identifier on the basis of the image. Alternatively the app prompts the user to capture, by the mobile device 2, an image of a machine-readable representation (identifier) of the product identifier of said product 3, e.g., a barcode or QR code encoding said product identifier. In other words, the method comprises a step S5 of capturing and selecting or of capturing as disclosed with respect to FIG. 7.

Subsequently, the method according to FIG. 10 comprises the steps disclosed with respect to FIG. 7 with the following exceptions:
Instead of placing the object 3 to be weighed on the weighing device 1 by the user, the method according to FIG. 10 comprises a step S20 of placing the object to be weighed inside the selected container. The selected container comprising the object to be weighed is placed then on the weighing device, wherein it is this placing on the weighing device that initiates the step S1 of generating a request for establishing a communication between the weighing device 1 and the mobile device 2.
After a communication was established by the step S4 of initiating a communication between the weighing device 1 and the mobile device 2, the tare information retrieved in the step S33 of retrieving tare information associated with the selected container by the mobile device 2 is communicated together with the product identifier to the weighing device. In other words, the method comprises a step S6 of communicating the product identifier as disclosed with respect to FIG. 7 and a step S21 of communicating tare information as disclosed with respect to FIG. 9.
Instead of weighing the object only (step S7 in FIG. 7), the method shown in FIG. 10 comprises a step S22 of determining a total weighing value of the object 3 and the selected container, this means a step S22 of weighing the object(s) 3 arranged in the container 4 together with the container 4 as disclosed with respect to FIG. 9. The step S8 of generating weighing transaction information by the weighing device 1 is then as disclosed with respect to FIG. 9.

### LIST OF REFERENCE SIGNS

1 weighing device
2 mobile device
3 object
4 container
5 touchscreen/user interface of the mobile device
6 server/remote device/remote system
7 Representation of unique session identifier
7′ Unique session identifier
8 Camera
9 Display means/display/user interface of the weighing device
10 Communication module of the weighing device
11 Communication module of the mobile device
12 Transceiver of the weighing device
13 Transceiver of the mobile device
14 Controller of the weighing device, weighing device processor
15 Controller of the mobile device, mobile device processor
16 Weighing device data carrier
17 Mobile device data carrier
21 First message
22 Second message
23 Third message
100 System
S1 Generating a request for establishing a communication
   S1a User input indicating user's intention to start a weighing process
S2 Generating a unique session identifier
   S2a Initiate generation of a unique session identifier
S3 Making sure that the pairing partners can be identified via the unique session
identifier
   S3a Acquiring a picture of a representation of the session identifier
   S3a Manual transfer of a representation of the session identifier
   S3b Transfer session identifier from weighing device to remote device
   S3c Transfer session identifier from remote device to weighing device
   S3c′ Attribute weighing device to session identifier
   S3d User confirmation that object was placed on weighing device
   S3e Transfer session identifier from remote device to mobile device
   S3e′ Attribute mobile device to session identifier
S4 Initiate a communication using the unique session identifier
   S4a Establishment of a direct communication
   S4b Establishment of an indirect communication
S5 Getting a product identifier
S6 Communicating the product identifier
S7 Weighing the object
S8 Generating weighing transaction information
S9 Communicating weighing transaction information
S10 Terminating communication
S20 Arranging the object(s) to be weighed in a container
S21 Communicating tare information associated with the container to the weighing device
S22 Weighing the object(s) arranged in the container together with the container
S23 Requesting creation of tare information associated with a container
S24 Capturing picture of the container
S25 Placing empty container on weighing device
S26 Weighing the empty container
S27 Creating tare information associated with the empty container
S28 Communicating tare information associated with the empty container
S29 Linking and storing the communicated tare information
S30 Inputting a weighing request into the mobile device
S31 Displaying containers on the touchscreen of the mobile device
S32 Selecting a displayed container
S33 Retrieving tare information of the selected container

1. A communication method between a weighing device and a mobile device, the method comprises a step of initiating a communication using a unique session identifier that is generated in reaction to a request for establishing the communication.

2. The communication method of claim 1, wherein the communication is an ad-hoc short-living communication.

3. The communication method of claim 1, wherein the request for establishing the communication is generated in a step of generating a request for establishing a communication, this step comprises at least one of:
placing an object on the weighing device;
establishing a near-field communication between the weighing device and the mobile device
a step of carrying out a user action on the mobile device.

4. The communication method of claim 1, further comprising a step of making sure that the weighing device and the mobile device can be identified via the unique session identifier.

5. The communication method of according to claim 4, wherein the step of making sure that the weighing device and the mobile device can be identified via the unique session identifier comprises at least one of:
a step of providing the unique session identifier to a communication module of the weighing device and to a communication module of the mobile device;
a step of attributing the weighing device and the mobile device to the unique session identifier.

6. The communication method of claim 5, further comprising the step of providing the unique session identifier to the communication module of the weighing device and to the communication module of the mobile device, wherein this step of providing comprises at least one of:
a step of detecting a representation of the unique session identifier;
a step by which the user provides a representation of the unique session identifier in a direct manner;
a step of transferring the unique session identifier from or via a remote system to at least one of the weighing device and the mobile device;
a step of establishing a near-field communication.

7. The communication method of claim 6, further comprising the step of detecting a representation of the unique session identifier, wherein the method further comprises:
providing means for scanning a barcode or QR code to the mobile device;
providing display means;
encoding the unique session identifier in a barcode or a QR-code and displaying the barcode or QR-code on the display means;
providing the generated unique session identifier to the mobile device by scanning the barcode or QR-code with the mobile device before the communication is established.

8. The communication method of claim 1, wherein:
the communication method comprises a step of establishing, using the unique session identifier, a direct communication between the weighing device and the mobile device or
the communication method comprises a step of establishing, using the unique session identifier, a communication between the weighing device and the mobile device via a remote system; or
the communication method comprises a step of distributing the unique session identifier via a remote system and a step of establishing, using the distributed unique session identifier, a communication between the weighing device and the mobile device, wherein the communication is either a direct communication or an indirect communication via the remote system.

9. A weighing method comprising the communication method of claim 1, and further comprising:
placing an object to be weighed on the weighing device said object being associated with a product identifier;
upon initiation of the communication, communicating the product identifier to the weighing device;
weighing of the object by the weighing device to thereby obtain a weighing value of the object and generating weighing transaction information at least on the basis of said weighing value and said product identifier;
communicating the weighing transaction information to the mobile device by the weighing device and thereafter terminating the communication between the weighing device and the mobile device.

10. The weighing method of claim 9, wherein placing the object to be weighed on the weighing device causes generation of the unique session identifier.

11. The weighing method of claim 9, wherein the method comprises a step of working through a product identifier list provided by the mobile device.

12. The weighing method of claim 9, further comprising a step of providing a data table, said data table comprising for each of a plurality of objects to be weighed the associated product identifier, and at least one of:
displaying a graphical representation of each object of said plurality on the mobile device, selecting the object to be weighed among the displayed objects via a user input, and retrieving the product identifier from the data table by the mobile device in response to the user input;
providing a camera to the mobile device, capturing an image of the object to be weighed by the camera, and automatically selecting said product identifier from the data table on the basis of the captured image.

13. The weighing method of claim 9, wherein said method further comprises:
providing a machine-readable representation of the product identifier of the object to be weighed;
providing a camera to the mobile device;
capturing an image of the machine-readable identifier representation by the camera and retrieving the product identifier on the basis of said image.

14-20. (canceled)

21. A weighing device configured to implement the method of claim 1.

22. (canceled)
